(19) United States
(12) Patent Application Publication
(10) Pub. No.: US 2026/0119242 A1
(43) Pub. Date: Apr. 30, 2026

(54) EFFICIENT MANAGEMENT OF CONTENT FOR AN INGESTION AND ANALYTICS MANAGEMENT PLATFORM

(71) Applicant: Cisco Technology, Inc., San Jose, CA (US)

(72) Inventors: Omprakaash THOPPAI, San Jose, CA (US); Amy Joanna Sutedja, Seattle, WA (US); Jiahong Zhu, Issaquah, WA (US); Arthur Foelsche, Montpelier, VT (US)

(21) Appl. No.: 18/927,662

(22) Filed: Oct. 25, 2024

(51) Int. Cl. G06F 9/50; G06F 11/07

(52) U.S. Cl. CPC G06F 9/5027; G06F 11/079

(57) ABSTRACT

Embodiments described herein are directed to efficient content management within a data-processing environment. In some embodiments, data is obtained at an edge processor. The edge processor may perform data processing in proximity to generation of the data and provide the processed data to a centralized computing service for subsequent processing or storage. At the edge processor, basic data processing may be performed to process the data based on a basic data processing pipeline executed on the edge processor. The basic data processing pipeline may use basic data processing content to perform the basic data processing. The processed data may be provided to a component of the centralized computing service.

### RELATED APPLICATIONS

Any and all applications for which a foreign or domestic priority claim is identified in the Application Data Sheet as filed with the present application are incorporated by reference under 37 CFR 1.57 and made a part of this specification.

### BACKGROUND

Information technology (IT) environments can include diverse types of data systems that store large amounts of diverse data types generated by numerous devices. For example, a big data ecosystem may include databases such as MySQL and Oracle databases, cloud computing services such as Amazon Web Services (AWS), and other data systems that store passively or actively generated data, including machine-generated data (“machine data”). The machine data can include log data, performance data, diagnostic data, metrics, tracing data, or any other data that can be analyzed to diagnose equipment performance problems, monitor user interactions, and to derive other insights.

The large amount and diversity of data systems containing large amounts of structured, semi-structured, and unstructured data relevant to any search query can be massive, and continues to grow rapidly. This technological evolution can give rise to various challenges in relation to managing, understanding, and effectively utilizing the data. To reduce the potentially vast amount of data that may be generated, some data systems pre-process data based on anticipated data analysis needs. In particular, specified data items may be extracted from the generated data and stored in a data system to facilitate efficient retrieval and analysis of those data items at a later time. At least some of the remainder of the generated data is typically discarded during pre-processing.

However, storing massive quantities of minimally processed or unprocessed data (collectively and individually referred to as “raw data”) for later retrieval and analysis is becoming increasingly more feasible as storage capacity becomes more inexpensive and plentiful. In general, storing raw data and performing analysis on that data later can provide greater flexibility because it enables an analyst to analyze all of the generated data instead of only a fraction of it. Although the availability of vastly greater amounts of diverse data on diverse data systems provides opportunities to derive new insights, it also gives rise to technical challenges to search and analyze the data in a performant way.

### BRIEF DESCRIPTION OF THE DRAWINGS

Illustrative examples are described in detail below with reference to the following figures:

FIG. 1 is a block diagram of an embodiment of a data processing environment.

FIG. 2 is a flow diagram illustrating an embodiment of a routine implemented by the data intake and query system to process, index, and store data.

FIG. 3A is a block diagram illustrating an embodiment of machine data received by the data intake and query system.

FIGS. 3B and 3C are block diagrams illustrating embodiments of various data structures for storing data processed by the data intake and query system.

FIG. 4A is a flow diagram illustrating an embodiment of a routine implemented by the query system to execute a query.

FIG. 4B provides a visual representation of the manner in which a pipelined command language or query can operate

FIG. 4C is a block diagram illustrating an embodiment of a configuration file that includes various extraction rules that can be applied to events.

FIG. 4D is a block diagram illustrating an example scenario where a common customer identifier is found among log data received from disparate data sources.

FIG. 5 illustrates an example data-processing environment data-processing environment to perform discovery and deployment of various processing content in association with one or more data processors, in accordance with various embodiments of the present disclosure.

FIG. 6 provides an example of a process that may be performed to facilitate efficient content management within a data-processing environment, in accordance with various embodiments of the present disclosure.

FIG. 7 provides another example of a process that may be performed to facilitate efficient content management within a data-processing environment, in accordance with various embodiments of the present technology

FIG. 8 provides another example of a process that may be performed to facilitate efficient content management within a data-processing environment, in accordance with embodiments described herein

FIG. 9 provides another example of a process that may be performed to facilitate efficient content management within a data-processing environment, in accordance with embodiments described herein.

### DETAILED DESCRIPTION

Modern data centers and other computing environments can comprise anywhere from a few host computer systems to thousands of systems configured to process data, service requests from remote clients, and perform numerous other computational tasks. During operation, various components within these computing environments often generate significant volumes of machine data. Machine data is any data produced by a machine or component in an information technology (IT) environment and that reflects activity in the IT environment. For example, machine data can be raw machine data that is generated by various components in IT environments, such as servers, sensors, routers, mobile devices, Internet-of-Things (IoT) devices, etc. Machine data can include system logs, network packet data, sensor data, application program data, error logs, stack traces, system performance data, etc. In general, machine data can also include performance data, diagnostic information, and many other types of data that can be analyzed to diagnose performance problems, monitor user interactions, and to derive other insights.

A number of tools are available to analyze machine data. In order to reduce the size of the potentially vast amount of machine data that may be generated, many of these tools typically pre-process the data based on anticipated data-analysis needs. For example, pre-specified data items may be extracted from the machine data and stored in a database to facilitate efficient retrieval and analysis of those data items at search time. However, the rest of the machine data typically is not saved and is discarded during pre-processing. As storage capacity becomes progressively cheaper and more plentiful, there are fewer incentives to discard these portions of machine data and many reasons to retain more of the data.

This plentiful storage capacity is presently making it feasible to store massive quantities of minimally processed machine data for later retrieval and analysis. In general, storing minimally processed machine data and performing analysis operations at search time can provide greater flexibility because it enables an analyst to search all of the machine data, instead of searching only a pre-specified set of data items. This may enable an analyst to investigate different aspects of the machine data that previously were unavailable for analysis.

However, analyzing and searching massive quantities of machine data presents a number of challenges. For example, a data center, servers, or network appliances may generate many different types and formats of machine data (e.g., system logs, network packet data (e.g., wire data, etc.), sensor data, application program data, error logs, stack traces, system performance data, operating system data, virtualization data, etc.) from thousands of different components, which can collectively be very time-consuming to analyze. In another example, mobile devices may generate large amounts of information relating to data accesses, application performance, operating system performance, network performance, etc. There can be millions of mobile devices that concurrently report these types of information.

These challenges can be addressed by using an event-based data intake and query system, such as the SPLUNK® ENTERPRISE, SPLUNK® CLOUD, or SPLUNK® CLOUD SERVICE system developed by Splunk Inc. of San Francisco, California. These systems represent the leading platform for providing real-time operational intelligence that enables organizations to collect, index, and search machine data from various websites, applications, servers, networks, and mobile devices that power their businesses. The data intake and query system is particularly useful for analyzing data that is commonly found in system log files, network data, metrics data, tracing data, and other data input sources.

In the data intake and query system, machine data is collected and stored as “events.” An event comprises a portion of machine data and is associated with a specific point in time. The portion of machine data may reflect activity in an IT environment and may be produced by a component of that IT environment, where the events may be searched to provide insight into the IT environment, thereby improving the performance of components in the IT environment. Events may be derived from “time series data,” where the time series data comprises a sequence of data points (e.g., performance measurements from a computer system, etc.) that are associated with successive points in time. In general, each event has a portion of machine data that is associated with a timestamp. The timestamp may be derived from the portion of machine data in the event, determined through interpolation between temporally proximate events having known timestamps, and/or may be determined based on other configurable rules for associating timestamps with events.

In some instances, machine data can have a predefined structure, where data items with specific data formats are stored at predefined locations in the data. For example, the machine data may include data associated with fields in a database table. In other instances, machine data may not have a predefined structure (e.g., may not be at fixed, predefined locations), but may have repeatable (e.g., non-random) patterns. This means that some machine data can comprise various data items of different data types that may be stored at different locations within the data. For example, when the data source is an operating system log, an event can include one or more lines from the operating system log containing machine data that includes different types of performance and diagnostic information associated with a specific point in time (e.g., a timestamp).

Examples of components that may generate machine data from which events can be derived include, but are not limited to, web servers, application servers, databases, firewalls, routers, operating systems, and software applications that execute on computer systems, mobile devices, sensors, Internet-of-Things (IoT) devices, etc. The machine data generated by such data sources can include, for example and without limitation, server log files, activity log files, configuration files, messages, network packet data, performance measurements, sensor measurements, etc.

The data intake and query system can use flexible schema to specify how to extract information from events. A flexible schema may be developed and redefined as needed. The flexible schema can be applied to events “on the fly,” when it is needed (e.g., at search time, index time, ingestion time, etc.). When the schema is not applied to events until search time, the schema may be referred to as a “late-binding schema.” During operation, the data intake and query system receives machine data from any type and number of sources (e.g., one or more system logs, streams of network packet data, sensor data, application program data, error logs, stack traces, system performance data, etc.). The system parses the machine data to produce events, each having a portion of machine data associated with a timestamp, and stores the events. The system enables users to run queries against the stored events to, for example, retrieve events that meet filter criteria specified in a query, such as criteria indicating certain keywords or having specific values in defined fields. Additional query terms can further process the event data, such as by transforming the data, etc.

As used herein, the term “field” can refer to a location in the machine data of an event containing one or more values for a specific data item. A field may be referenced by a field name associated with the field. As will be described in more detail herein, in some cases, a field is defined by an extraction rule (e.g., a regular expression) that derives one or more values or a sub-portion of text from the portion of machine data in each event to produce a value for the field for that event. The set of values produced are semantically related (such as by IP address), even though the machine data in each event may be in different formats (e.g., semantically related values may be in different positions in the events derived from different sources).

As described above, the system stores the events in a data store. The events stored in the data store are field-searchable, where field-searchable herein refers to the ability to search the machine data (e.g., the raw machine data) of an event based on a field specified in search criteria. For example, a search having criteria that specifies a field name “UserID” may cause the system to field search the machine data of events to identify events that have the field name “UserID.” In another example, a search having criteria that specifies a field name “UserID” with a corresponding field value “12345” may cause the system to field search the machine data of events to identify events having that field-value pair (e.g., field name “UserID” with a corresponding field value of “12345”). Events are field-searchable using one or more configuration files associated with the events. Each configuration file can include one or more field names, where each field name is associated with a corresponding extraction rule and a set of events to which that extraction rule applies. The set of events to which an extraction rule applies may be identified by metadata associated with the set of events. For example, an extraction rule may apply to a set of events that are each associated with a particular host, source, or sourcetype. When events are to be searched based on a particular field name specified in a search, the system can use one or more configuration files to determine whether there is an extraction rule for that particular field name that applies to each event that falls within the criteria of the search. If so, the event is considered as part of the search results (and additional processing may be performed on that event based on criteria specified in the search). If not, the next event is similarly analyzed, and so on.

As noted above, the data intake and query system can utilize a late-binding schema while performing queries on events. One aspect of a late-binding schema is applying extraction rules to events to extract values for specific fields during search time. More specifically, the extraction rule for a field can include one or more instructions that specify how to extract a value for the field from an event. An extraction rule can generally include any type of instruction for extracting values from machine data or events. In some cases, an extraction rule comprises a regular expression, where a sequence of characters form a search pattern. An extraction rule comprising a regular expression is referred to herein as a regex rule. The system applies a regex rule to machine data or an event to extract values for a field associated with the regex rule, where the values are extracted by searching the machine data/event for the sequence of characters defined in the regex rule.

In the data intake and query system, a field extractor may be configured to automatically generate extraction rules for certain fields in the events when the events are being created, indexed, or stored, or possibly at a later time. Alternatively, a user may manually define extraction rules for fields using a variety of techniques. In contrast to a conventional schema for a database system, a late-binding schema is not defined at data-ingestion time. Instead, the late-binding schema can be developed on an ongoing basis until the time a query is actually executed. This means that extraction rules for the fields specified in a query may be provided in the query itself, or may be located during execution of the query. Hence, as a user learns more about the data in the events, the user can continue to refine the late-binding schema by adding new fields, deleting fields, or modifying the field extraction rules for use the next time the schema is used by the system. Because the data intake and query system maintains the underlying machine data and uses a late-binding schema for searching the machine data, it enables a user to continue investigating and learn valuable insights about the machine data.

In some embodiments, a common field name may be used to reference two or more fields containing equivalent and/or similar data items, even though the fields may be associated with different types of events that possibly have different data formats and different extraction rules. By enabling a common field name to be used to identify equivalent and/or similar fields from different types of events generated by disparate data sources, the system facilitates use of a “common information model” (CIM) across the disparate data sources.

In some embodiments, the configuration files and/or extraction rules described above can be stored in a catalog, such as a metadata catalog. In certain embodiments, the content of the extraction rules can be stored as rules or actions in the metadata catalog. For example, the identification of the data to which the extraction rule applies can be referred to a rule, and the processing of the data can be referred to as an action.

### 1.0. OPERATING ENVIRONMENT

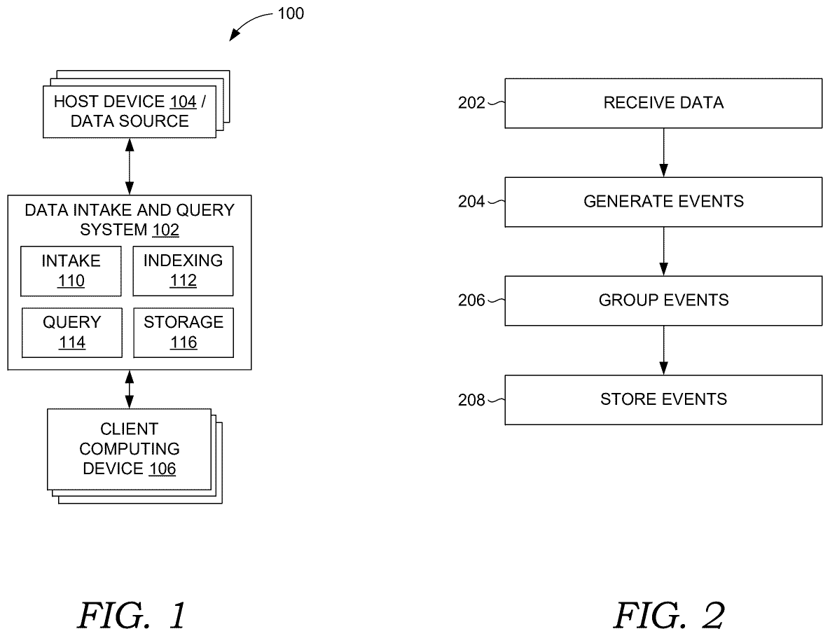

FIG. 1 is a block diagram of an embodiment of a data-processing environment 100. In the illustrated embodiment, the environment 100 includes a data intake and query system 102, one or more host devices 104, and one or more client computing devices 106 (generically referred to as client device[s] 106).

The data intake and query system 102, host devices 104, and client devices 106 can communicate with each other via one or more networks, such as a local area network (LAN), wide area network (WAN), private or personal network, cellular networks, intranetworks, and/or internetworks using any of wired, wireless, terrestrial microwave, satellite links, etc., and may include the Internet. Although not explicitly shown in FIG. 1, it will be understood that a client computing device 106 can communicate with a host device 104 via one or more networks. For example, if the host device 104 is configured as a web server and the client computing device 106 is a laptop, the laptop can communicate with the web server to view a website.

A client device 106 can correspond to a distinct computing device that can configure, manage, or send queries to the system 102. Examples of client devices 106 may include, without limitation, smart phones, tablet computers, handheld computers, wearable devices, laptop computers, desktop computers, servers, portable media players, gaming devices, or other device that includes computer hardware (e.g., processors, non-transitory, computer-readable media, etc.) and so forth. In certain cases, a client device 106 can include a hosted, virtualized, or containerized device, such as an isolated execution environment, that shares computing resources (e.g., processor, memory, etc.) of a particular machine with other isolated execution environments.

The client devices 106 can interact with the system 102 (or a host device 104) in a variety of ways. For example, the client devices 106 can communicate with the system 102 (or a host device 104) over an Internet (Web) protocol, via a gateway, via a command line interface, via a software developer kit (SDK), a standalone application, etc. As another example, the client devices 106 can use one or more executable applications or programs to interface with the system 102.

A host device 104 can correspond to a distinct computing device or system that includes or has access to data that can be ingested, indexed, and/or searched by the system 102. Accordingly, in some cases, a client device 106 may also be a host device 104 (e.g., it can include data that is ingested by the system 102, and it can submit queries to the system 102). The host devices 104 can include, but are not limited to, servers, sensors, routers, personal computers, mobile devices, Internet-of-Things (IOT) devices, or hosting devices, such as computing devices in a shared computing resource environment on which multiple isolated execution environments (e.g., virtual machines, containers, etc.) can be instantiated, or other computing devices in an IT environment (e.g., device that includes computer hardware, e.g., processors, non-transitory, computer-readable media, etc.). In certain cases, a host device 104 can include a hosted, virtualized, or containerized device, such as an isolated execution environment, that shares computing resources (e.g., processor, memory, etc.) of a particular machine (e.g., a hosting device or hosting machine) with other isolated execution environments.

As mentioned, host devices 104 can include or have access to data sources for the system 102. The data sources can include machine data found in log files, data files, distributed file systems, streaming data, publication-subscribe (pub/sub) buffers, directories of files, data sent over a network, event logs, registries, streaming data services (examples of which can include, by way of non-limiting example, Amazon's Simple Queue Service (“SQS”) or Kinesis™ services, devices executing Apache Kafka™ software, or devices implementing the Message Queue Telemetry Transport (MQTT) protocol, Microsoft Azure EventHub, Google Cloud PubSub, devices implementing the Java Message Service (JMS) protocol, devices implementing the Advanced Message Queuing Protocol [AMQP]), cloud-based services (e.g., AWS, Microsoft Azure, Google Cloud, etc.), operating-system-level virtualization environments (e.g., Docker), container orchestration systems (e.g., Kubernetes), virtual machines using full virtualization or paravirtualization, or other virtualization techniques or isolated execution environments.

In some cases, one or more applications executing on a host device may generate various types of machine data during operation. For example, a web server application executing on a host device 104 may generate one or more web server logs detailing interactions between the web server and any number of client devices 106 or other devices. As another example, a host device 104 implemented as a router may generate one or more router logs that record information related to network traffic managed by the router. As yet another example, a database server application executing on a host device 104 may generate one or more logs that record information related to requests sent from other devices (e.g., web servers, application servers, client devices, etc.) for data managed by the database server. Similarly, a host device 104 may generate and/or store computing resource utilization metrics, such as, but not limited to, CPU utilization, memory utilization, number of processes being executed, etc. Any one or any combination of the files or data generated in such cases can be used as a data source for the system 102.

In some embodiments, an application may include a monitoring component that facilitates generating performance data related to the host device's operating state, including monitoring network traffic sent and received from the host device and collecting other device-and/or application-specific information. A monitoring component may be an integrated component of the application, a plug-in, an extension, or any other type of add-on component, or a standalone process.

Such monitored information may include, but is not limited to, network performance data (e.g., a URL requested, a connection type (e.g., HTTP, HTTPS, etc.), a connection start time, a connection end time, an HTTP status code, request length, response length, request headers, response headers, connection status (e.g., completion, response time[s], failure, etc.) or device performance information (e.g., current wireless signal strength of the device, a current connection type and network carrier, current memory performance information, processor utilization, memory utilization, a geographic location of the device, a device orientation, and any other information related to the operational state of the host device, etc.), device profile information (e.g., a type of client device, a manufacturer, and model of the device, versions of various software applications installed on the device, etc.) In some cases, the monitoring component can collect device performance information by monitoring one or more host device operations, or by making calls to an operating system and/or one or more other applications executing on a host device for performance information. The monitored information may be stored in one or more files and/or streamed to the system 102.

In general, a monitoring component may be configured to generate performance data in response to a monitor trigger in the code of a client application or other triggering application event, as described above, and to store the performance data in one or more data records. Each data record, for example, may include a collection of field-value pairs, each field-value pair storing a particular item of performance data in association with a field for the item. For example, a data record generated by a monitoring component may include a “network latency” field (not shown in the Figure) in which a value is stored. This field indicates a network latency measurement associated with one or more network requests. The data record may include a “state” field to store a value indicating a state of a network connection, and so forth for any number of aspects of collected performance data.

In some embodiments, such as in a shared computing resource environment (or hosted environment), a host device 104 may include logs or machine data generated by an application executing within an isolated execution environment (e.g., web server log file if the isolated execution environment is configured as a web server or database server log files if the isolated execution environment is configured as database server, etc.), machine data associated with the computing resources assigned to the isolated execution environment (e.g., CPU utilization of the portion of the CPU allocated to the isolated execution environment, memory utilization of the portion of the memory allocated to the isolated execution environment, etc.), logs or machine data generated by an application that enables the isolated execution environment to share resources with other isolated execution environments (e.g., logs generated by a Docker manager or Kubernetes manager executing on the host device 104), and/or machine data generated by monitoring the computing resources of the host device 104 (e.g., CPU utilization, memory utilization, etc.) that are shared between the isolated execution environments. Given the separation (and isolation) between isolated execution environments executing on a common computing device, in certain embodiments, each isolated execution environment may be treated as a separate host device 104 even if they are, in fact, executing on the same computing device or hosting device.

Accordingly, as used herein, obtaining data from a data source may refer to communicating with a host device 104 to obtain data from the host device 104 (e.g., from one or more data source files, data streams, directories on the host device 104, etc.). For example, obtaining data from a data source may refer to requesting data from a host device 104 and/or receiving data from a host device 104. In some such cases, the host device 104 can retrieve and return the requested data from a particular data source, and/or the system 102 can retrieve the data from a particular data source of the host device 104 (e.g., from a particular file stored on a host device 104).

The data intake and query system 102 can ingest, index, and/or store data from heterogeneous data sources and/or host devices 104. For example, the system 102 can ingest, index, and/or store any type of machine data, regardless of the form of the machine data or whether the machine data matches or is similar to other machine data ingested, indexed, and/or stored by the system 102. In some cases, the system 102 can generate events from the received data, group the events, and store the events in buckets. The system 102 can also search heterogeneous data that it has stored or search data stored by other systems (e.g., other system 102 systems or other non-system 102 systems). For example, in response to received queries, the system 102 can assign one or more components to search events stored in the storage system or search data stored elsewhere.

As will be described herein in greater detail below, the system 102 can use one or more components to ingest, index, store, and/or search data. In some embodiments, the system 102 is implemented as a distributed system that uses multiple components to perform its various functions. For example, the system 102 can include any one or any combination of an intake system 110 (including one or more components) to ingest data, an indexing system 112 (including one or more components) to index the data, a storage system 116 (including one or more components) to store the data, and/or a query system 114 (including one or more components) to search the data, etc.

In the illustrated embodiment, the system 102 is shown having four subsystems 110, 112, 114, and 116. However, it will be understood that the system 102 may include any one or any combination of the intake system 110, indexing system 112, query system 114, or storage system 116. Further, in certain embodiments, one or more of the intake system 110, indexing system 112, query system 114, or storage system 116 may be used alone or apart from the system 102. For example, the intake system 110 may be used alone to glean information from streaming data that is not indexed or stored by the system 102, or the query system 114 may be used to search data that is unaffiliated with the system 102.

In certain embodiments, the components of the different systems may be distinct from each other or there may be some overlap. For example, one component of the system 102 may include some indexing functionality and some searching functionality and thus be used as part of the indexing system 112 and query system 114, while another computing device of the system 102 may only have ingesting or search functionality and only be used as part of those respective systems. Similarly, the components of the storage system 116 may include data stores of individual components of the indexing system and/or may be a separate shared data storage system, like Amazon S3, that is accessible to distinct components of the intake system 110, indexing system 112, and query system 114.

In some cases, the components of the system 102 are implemented as distinct computing devices having their own computer hardware (e.g., processors, non-transitory, computer-readable media, etc.) and/or as distinct hosted devices (e.g., isolated execution environments) that share computing resources or hardware in a shared computing resource environment.

For simplicity, references made herein to the intake system 110, indexing system 112, storage system 116, and query system 114 can refer to those components used for ingesting, indexing, storing, and searching, respectively. However, it will be understood that although reference is made to two separate systems, the same underlying component may be performing the functions for the two different systems. For example, reference to the indexing system indexing data and storing the data in the storage system 116 or the query system searching the data may refer to the same component (e.g., same computing device or hosted device) indexing the data, storing the data, and then searching the data that it stored.

As will be described in greater detail herein, the intake system 110 can receive data from the host devices 104 or data sources, perform one or more preliminary processing operations on the data, and communicate the data to the indexing system 112, query system 114, storage system 116, or to other systems (which may include, for example, data-processing systems, telemetry systems, real-time analytics systems, data stores, databases, etc., any of which may be operated by an operator of the system 102 or a third party). Given the amount of data that can be ingested by the intake system 110, in some embodiments, the intake system can include multiple distributed computing devices or components working concurrently to ingest the data.

The intake system 110 can receive data from the host devices 104 in a variety of formats or structures. In some embodiments, the received data corresponds to raw machine data, structured or unstructured data, correlation data, data files, directories of files, data sent over a network, event logs, registries, messages published to streaming data sources, performance metrics, sensor data, image and video data, etc.

The preliminary processing operations performed by the intake system 110 can include, but is not limited to, associating metadata with the data received from a host device 104, extracting a timestamp from the data, identifying individual events within the data, extracting a subset of machine data for transmittal to the indexing system 112, enriching the data, etc. As part of communicating the data to the indexing system, the intake system 110 can route the data to a particular component of the intake system 110 or dynamically route the data based on load-balancing, etc. In certain cases, one or more components of the intake system 110 can be installed on a host device 104.

### 1.4.2. INDEXING SYSTEM OVERVIEW

As will be described in greater detail herein, the indexing system 112 can include one or more components (e.g., indexing nodes) to process the data and store it, for example, in the storage system 116. As part of processing the data, the indexing system can identify distinct events within the data, timestamps associated with the data, organize the data into buckets or time series buckets, convert editable buckets to non-editable buckets, store copies of the buckets in the storage system 116, merge buckets, generate indexes of the data, etc. In addition, the indexing system 112 can update various catalogs or databases with information related to the buckets (pre-merged or merged) or data that is stored in the storage system 116, and can communicate with the intake system 110 about the status of the data storage.

As will be described in greater detail herein, the query system 114 can include one or more components to receive, process, and execute queries. In some cases, the query system 114 can use the same component to process and execute the query or use one or more components to receive and process the query (e.g., a search head) and use one or more other components to execute at least a portion of the query (e.g., search nodes). In some cases, a search node and an indexing node may refer to the same computing device or hosted device performing different functions. In certain cases, a search node can be a separate computing device or hosted device from an indexing node.

Queries received by the query system 114 can be relatively complex and identify a set of data to be processed and a manner of processing the set of data from one or more client devices 106. In certain cases, the query can be implemented using a pipelined command language or other query language. As described herein, in some cases, the query system 114 can execute parts of the query in a distributed fashion (e.g., one or more mapping phases or parts associated with identifying and gathering the set of data identified in the query) and execute other parts of the query on a single component (e.g., one or more reduction phases). However, it will be understood that in some cases multiple components can be used in the map and/or reduce functions of the query execution.

In some cases, as part of executing the query, the query system 114 can use one or more catalogs or databases to identify the set of data to be processed or its location in the storage system 116 and/or can retrieve data from the storage system 116. In addition, in some embodiments, the query system 114 can store some or all of the query results in the storage system 116.

In some cases, the storage system 116 may include one or more data stores associated with or coupled to the components of the indexing system 112 that are accessible via a system bus or local area network. In certain embodiments, the storage system 116 may be a shared storage system 116, like Amazon S3 or Google Cloud Storage, that are accessible via a wide area network.

As mentioned and as will be described in greater detail below, the storage system 116 can be made up of one or more data stores storing data that has been processed by the indexing system 112. In some cases, the storage system includes data stores of the components of the indexing system 112 and/or query system 114. In certain embodiments, the storage system 116 can be implemented as a shared storage system 116. The shared storage system 116 can be configured to provide high-availability, highly resilient, low-loss data storage. In some cases, to provide the high-availability, highly resilient, low-loss data storage, the shared storage system 116 can store multiple copies of the data in the same and different geographic locations and across different types of data stores (e.g., solid-state, hard drive, tape, etc.). Further, as data is received at the shared storage system 116, it can be automatically replicated multiple times according to a replication factor to different data stores across the same and/or different geographic locations. In some embodiments, the shared storage system 116 can correspond to cloud storage, such as Amazon Simple Storage Service (S3) or Elastic Block Storage (EBS), Google Cloud Storage, Microsoft Azure Storage, etc.

In some embodiments, indexing system 112 can read to and write from the shared storage system 116. For example, the indexing system 112 can copy buckets of data from its local or shared data stores to the shared storage system 116. In certain embodiments, the query system 114 can read from, but cannot write to, the shared storage system 116. For example, the query system 114 can read the buckets of data stored in shared storage system 116 by the indexing system 112, but may not be able to copy buckets or other data to the shared storage system 116. In some embodiments, the intake system 110 does not have access to the shared storage system 116. However, in some embodiments, one or more components of the intake system 110 can write data to the shared storage system 116 that can be read by the indexing system 112.

As described herein, in some embodiments, data in the system 102 (e.g., in the data stores of the components of the indexing system 112, shared storage system 116, or search nodes of the query system 114) can be stored in one or more time series buckets. Each bucket can include raw machine data associated with a timestamp and additional information about the data or bucket, such as, but not limited to, one or more filters, indexes (e.g., TSIDX, inverted indexes, keyword indexes, etc.), bucket summaries, etc. In some embodiments, the bucket data and information about the bucket data is stored in one or more files. For example, the raw machine data, filters, indexes, bucket summaries, etc., can be stored in respective files in or associated with a bucket. In certain cases, the group of files can be associated together to form the bucket.

The system 102 can include additional components that interact with any one or any combination of the intake system 110, indexing system 112, query system 114, and/or storage system 116. Such components may include, but are not limited to, an authentication system, orchestration system, one or more catalogs or databases, a gateway, etc.

An authentication system can include one or more components to authenticate users to access, use, and/or configure the system 102. Similarly, the authentication system can be used to restrict what a particular user can do on the system 102 and/or what components or data a user can access, etc.

An orchestration system can include one or more components to manage and/or monitor the various components of the system 102. In some embodiments, the orchestration system can monitor the components of the system 102 to detect when one or more components has failed or is unavailable and enable the system 102 to recover from the failure (e.g., by adding additional components, fixing the failed component, or having other components complete the tasks assigned to the failed component). In certain cases, the orchestration system can determine when to add components to or remove components from a particular system 110, 112, 114, and 116 (e.g., based on usage, user/tenant requests, etc.). In embodiments where the system 102 is implemented in a shared computing resource environment, the orchestration system can facilitate the creation and/or destruction of isolated execution environments or instances of the components of the system 102, etc.

In certain embodiments, the system 102 can include various components that enable it to provide stateless services or enable it to recover from an unavailable or unresponsive component without data loss in a time efficient manner. For example, the system 102 can store contextual information about its various components in a distributed way such that if one of the components becomes unresponsive or unavailable, the system 102 can replace the unavailable component with a different component and provide the replacement component with the contextual information. In this way, the system 102 can quickly recover from an unresponsive or unavailable component while reducing or eliminating the loss of data that was being processed by the unavailable component.

In some embodiments, the system 102 can store the contextual information in a catalog, as described herein. In certain embodiments, the contextual information can correspond to information that the system 102 has determined or learned based on use. In some cases, the contextual information can be stored as annotations (manual annotations and/or system annotations), as described herein.

In certain embodiments, the system 102 can include an additional catalog that monitors the location and storage of data in the storage system 116 to facilitate efficient access of the data during search time. In certain embodiments, such a catalog may form part of the storage system 116.

In some embodiments, the system 102 can include a gateway or other mechanism to interact with external devices or to facilitate communications between components of the system 102. In some embodiments, the gateway can be implemented using an application programming interface (API). In certain embodiments, the gateway can be implemented using a representational state transfer API (REST API).

In some environments, a user of a system 102 may install and configure, on computing devices owned and operated by the user, one or more software applications that implement some or all of the components of the system 102. For example, with reference to FIG. 1, a user may install a software application on server computers owned by the user and configure each server to operate as one or more components of the intake system 110, indexing system 112, query system 114, shared storage system 116, or other components of the system 102. This arrangement generally may be referred to as an “on-premises” solution. That is, the system 102 is installed and operates on computing devices directly controlled by the user of the system 102. Some users may prefer an on-premises solution because it may provide a greater level of control over the configuration of certain aspects of the system (e.g., security, privacy, standards, controls, etc.). However, other users may instead prefer an arrangement in which the user is not directly responsible for providing and managing the computing devices upon which various components of system 102 operate.

In certain embodiments, one or more of the components of the system 102 can be implemented in a shared computing resource environment. In this context, a shared computing resource environment or cloud-based service can refer to a service hosted by one more computing resources that are accessible to end users over a network, for example, by using a web browser or other application on a client device to interface with the remote computing resources. For example, a service provider may provide a system 102 by managing computing resources configured to implement various aspects of the system (e.g., intake system 110, indexing system 112, query system 114, shared storage system 116, other components, etc.) and by providing access to the system to end users via a network. Typically, a user may pay a subscription or other fee to use such a service. Each subscribing user of the cloud-based service may be provided with an account that enables the user to configure a customized cloud-based system based on the user's preferences.

When implemented in a shared computing resource environment, the underlying hardware (non-limiting examples: processors, hard drives, solid-state memory, RAM, etc.) on which the components of the system 102 execute can be shared by multiple customers or tenants as part of the shared computing resource environment. In addition, when implemented in a shared computing resource environment as a cloud-based service, various components of the system 102 can be implemented using containerization or operating-system-level virtualization, or other virtualization technique. For example, one or more components of the intake system 110, indexing system 112, or query system 114 can be implemented as separate software containers or container instances. Each container instance can have certain computing resources (e.g., memory, processor, etc.) of an underlying hosting computing system (e.g., server, microprocessor, etc.) assigned to it, but may share the same operating system and may use the operating system's system call interface. Each container may provide an isolated execution environment on the host system, such as by providing a memory space of the hosting system that is logically isolated from the memory space of other containers. Further, each container may run the same or different computer applications concurrently or separately, and may interact with each other. Although reference is made herein to containerization and container instances, it will be understood that other virtualization techniques can be used. For example, the components can be implemented using virtual machines using full virtualization or paravirtualization, etc. Thus, where reference is made to “containerized” components, it should be understood that such components may additionally or alternatively be implemented in other isolated execution environments, such as a virtual machine environment.

Implementing the system 102 in a shared computing resource environment can provide a number of benefits. In some cases, implementing the system 102 in a shared computing resource environment can make it easier to install, maintain, and update the components of the system 102. For example, rather than accessing designated hardware at a particular location to install or provide a component of the system 102, a component can be remotely instantiated or updated as desired. Similarly, implementing the system 102 in a shared computing resource environment or as a cloud-based service can make it easier to meet dynamic demand. For example, if the system 102 experiences significant load at indexing or search, additional compute resources can be deployed to process the additional data or queries. In an “on-premises” environment, this type of flexibility and scalability may not be possible or feasible.

In addition, by implementing the system 102 in a shared computing resource environment or as a cloud-based service can improve compute resource utilization. For example, in an on-premises environment, if the designated compute resources are not being used, they may sit idle and unused. In a shared computing resource environment, if the compute resources for a particular component are not being used, they can be reallocated to other tasks within the system 102 and/or to other systems unrelated to the system 102.

As mentioned, in an on-premises environment, data from one instance of a system 102 is logically and physically separated from the data of another instance of a system 102 by virtue of each instance having its own designated hardware. As such, data from different customers of the system 102 is logically and physically separated from each other. In a shared computing resource environment, components of a system 102 can be configured to process the data from one customer or tenant or from multiple customers or tenants. Even in cases where a separate component of a system 102 is used for each customer, the underlying hardware on which the components of the system 102 are instantiated may still process data from different tenants. Accordingly, in a shared computing resource environment, the data from different tenants may not be physically separated on distinct hardware devices. For example, data from one tenant may reside on the same hard drive as data from another tenant or be processed by the same processor. In such cases, the system 102 can maintain logical separation between tenant data. For example, the system 102 can include separate directories for different tenants and apply different permissions and access controls to access the different directories or to process the data, etc.

In certain cases, the tenant data from different tenants is mutually exclusive and/or independent from each other. For example, in certain cases, Tenant A and Tenant B do not share the same data, similar to the way in which data from a local hard drive of Customer A is mutually exclusive and independent of the data (and not considered part of) of a local hard drive of Customer B. While Tenant A and Tenant B may have matching or identical data, each tenant would have a separate copy of the data. For example, with reference again to the local hard drive of Customer A and Customer B example, each hard drive could include the same file. However, each instance of the file would be considered part of the separate hard drive and would be independent of the other file. Thus, one copy of the file would be part of Customer A's hard drive, and a separate copy of the file would be part of Customer B's hard drive. In a similar manner, to the extent Tenant A has a file that is identical to a file of Tenant B, each tenant would have a distinct and independent copy of the file stored in different locations on a data store or on different data stores.

Further, in certain cases, the system 102 can maintain the mutual exclusivity and/or independence between tenant data even as the tenant data is being processed, stored, and searched by the same underlying hardware. In certain cases, to maintain the mutual exclusivity and/or independence between the data of different tenants, the system 102 can use tenant identifiers to uniquely identify data associated with different tenants.

In a shared computing resource environment, some components of the system 102 can be instantiated and designated for individual tenants, and other components can be shared by multiple tenants. In certain embodiments, a separate intake system 110, indexing system 112, and query system 114 can be instantiated for each tenant, whereas the shared storage system 116 or other components (e.g., data store, metadata catalog, and/or acceleration data store, described below) can be shared by multiple tenants. In some such embodiments where components are shared by multiple tenants, the components can maintain separate directories for the different tenants to ensure their mutual exclusivity and/or independence from each other. Similarly, in some such embodiments, the system 102 can use different hosting computing systems or different isolated execution environments to process the data from the different tenants as part of the intake system 110, indexing system 112, and/or query system 114.

In some embodiments, individual components of the intake system 110, indexing system 112, and/or query system 114 may be instantiated for each tenant or shared by multiple tenants. For example, some individual intake system components (e.g., forwarders, output ingestion buffers, etc.) may be instantiated and designated for individual tenants, while other intake system components (e.g., a data retrieval subsystem, intake ingestion buffer, and/or streaming data processor), may be shared by multiple tenants.

In certain embodiments, an indexing system 112 (or certain components thereof) can be instantiated and designated for a particular tenant or shared by multiple tenants. In some embodiments where a separate indexing system 112 is instantiated and designated for each tenant, different resources can be reserved for different tenants. For example, Tenant A can be consistently allocated a minimum of four indexing nodes, and Tenant B can be consistently allocated a minimum of two indexing nodes. In some such embodiments, the four indexing nodes can be reserved for Tenant A, and the two indexing nodes can be reserved for Tenant B, even if Tenant A and Tenant B are not using the reserved indexing nodes.

In embodiments where an indexing system 112 is shared by multiple tenants, components of the indexing system 112 can be dynamically assigned to different tenants. For example, if Tenant A has greater indexing demands, additional indexing nodes can be instantiated or assigned to Tenant A's data. However, as the demand decreases, the indexing nodes can be reassigned to a different tenant, or terminated. Further, in some embodiments, a component of the indexing system 112 can concurrently process data from the different tenants.

In some embodiments, one instance of query system 114 may be shared by multiple tenants. In some such cases, the same search head can be used to process/execute queries for different tenants, and/or the same search nodes can be used to execute queries for different tenants. Further, in some such cases, different tenants can be allocated different amounts of compute resources. For example, Tenant A may be assigned more search heads or search nodes than another tenant based on demand or based on a service-level arrangement. However, once a search is completed, the search head and/or nodes assigned to Tenant A may be assigned to Tenant B, deactivated, or their resource may be reallocated to other components of the system 102, etc.

In some cases, by sharing more components with different tenants, the functioning of the system 102 can be improved. For example, by sharing components across tenants, the system 102 can improve resource utilization, thereby reducing the amount of resources allocated as a whole. For example, if four indexing nodes, two search heads, and four search nodes are reserved for each tenant, then those compute resources are unavailable for use by other processes or tenants, even if they go unused. In contrast, by sharing the indexing nodes, search heads, and search nodes with different tenants and instantiating additional compute resources, the system 102 can use fewer resources overall while providing improved processing time for the tenants that are using the compute resources. For example, if tenant A is not using any search nodes 506 and tenant B has many searches running, the system 102 can use search nodes that would have been reserved for tenant A to service tenant B. In this way, the system 102 can decrease the number of compute resources used/reserved, while improving the search time for tenant B and improving compute resource utilization.

### 2.0. DATA INGESTION, INDEXING, AND STORAGE

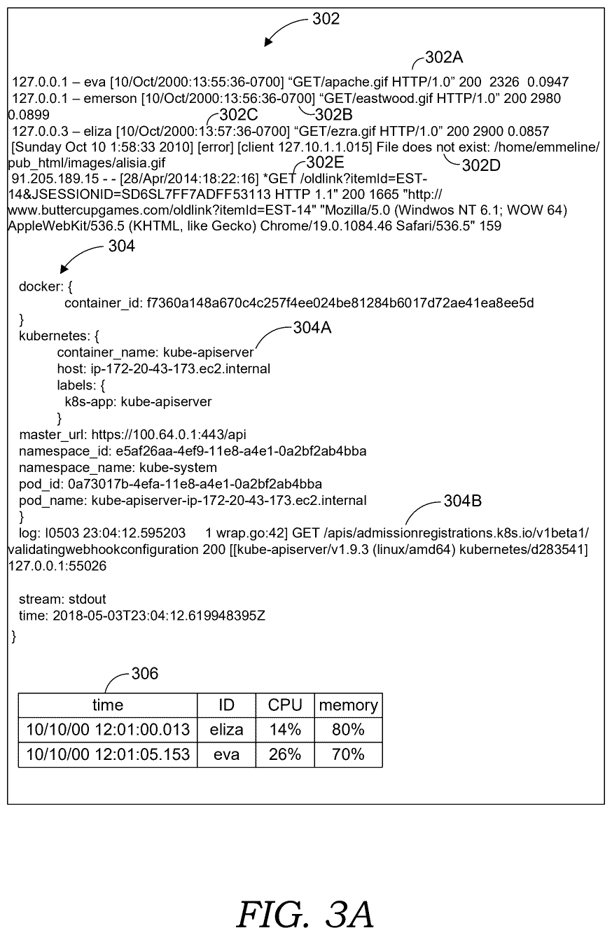

FIG. 2 is a flow diagram illustrating an embodiment of a routine implemented by the system 102 to process, index, and store data received from host devices 104. The data flow illustrated in FIG. 2 is provided for illustrative purposes only. It will be understood that one or more of the steps of the processes illustrated in FIG. 2 may be removed or that the ordering of the steps may be changed. Furthermore, for the purposes of illustrating a clear example, one or more particular system components are described in the context of performing various operations during each of the data flow stages. For example, the intake system 110 is described as receiving machine data, and the indexing system 112 is described as generating events, grouping events, and storing events. However, other system arrangements and distributions of the processing steps across system components may be used. For example, in some cases, the intake system 110 may generate events.

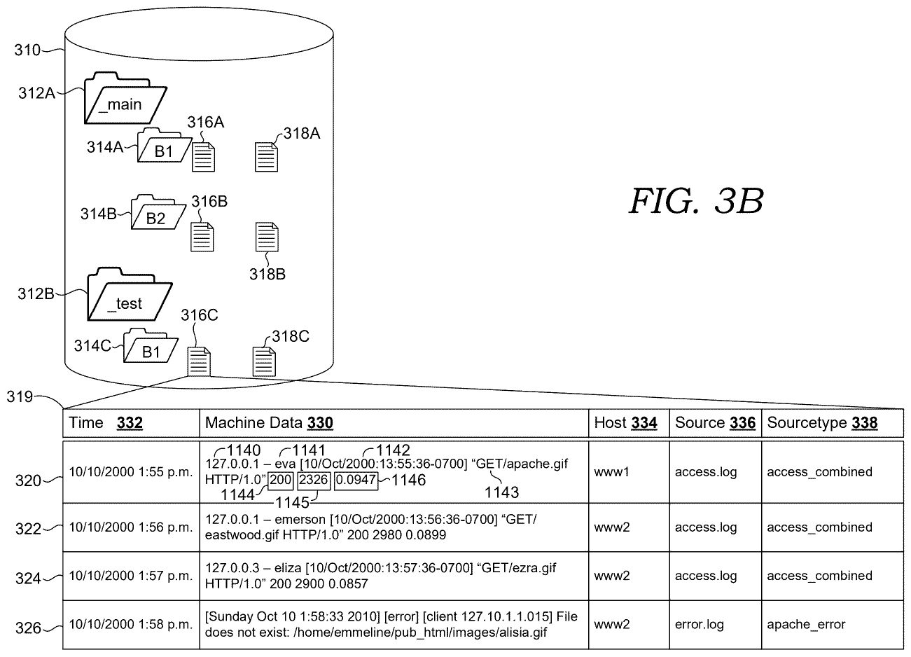

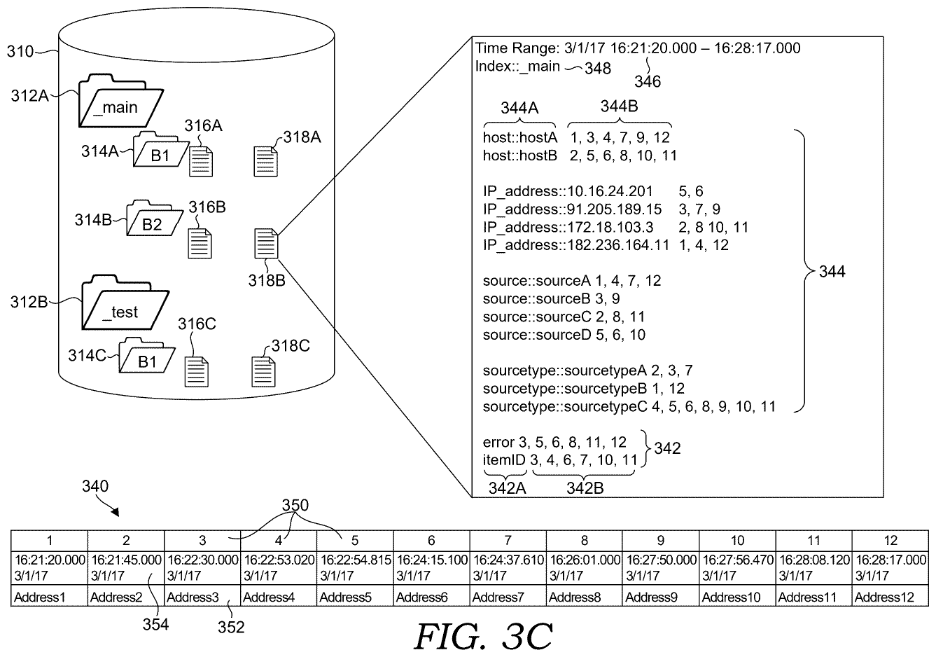

At block 202, the intake system 110 receives data from a host device 104. The intake system 110 initially may receive the data as a raw data stream generated by the host device 104. For example, the intake system 110 may receive a data stream from a log file generated by an application server, from a stream of network data from a network device, or from any other source of data. Non-limiting examples of machine data that can be received by the intake system 110 are described herein with reference to FIG. 3A.

In some embodiments, the intake system 110 receives the raw data and may segment the data stream into messages, possibly of a uniform data size, to facilitate subsequent processing steps. The intake system 110 may thereafter process the messages in accordance with one or more rules to conduct preliminary processing of the data. In one embodiment, the processing conducted by the intake system 110 may be used to indicate one or more metadata fields applicable to each message. For example, the intake system 110 may include metadata fields within the messages, or publish the messages to topics indicative of a metadata field. These metadata fields may, for example, provide information related to a message as a whole and may apply to each event that is subsequently derived from the data in the message. For example, the metadata fields may include separate fields specifying each of a host, a source, and a sourcetype related to the message. A host field may contain a value identifying a host name or IP address of a device that generated the data. A source field may contain a value identifying a source of the data, such as a pathname of a file or a protocol and port related to received network data. A sourcetype field may contain a value specifying a particular sourcetype label for the data. Additional metadata fields may also be included, such as a character encoding of the data, if known, and possibly other values that provide information relevant to later processing steps. In certain embodiments, the intake system 110 may perform additional operations, such as, but not limited to, identifying individual events within the data, determining timestamps for the data, further enriching the data, etc.

At block 204, the indexing system 112 generates events from the data. In some cases, as part of generating the events, the indexing system 112 can parse the data of the message. In some embodiments, the indexing system 112 can determine a sourcetype associated with each message (e.g., by extracting a sourcetype label from the metadata fields associated with the message, etc.) and refer to a sourcetype configuration corresponding to the identified sourcetype to parse the data of the message. The sourcetype definition may include one or more properties that indicate to the indexing system 112 to automatically determine the boundaries within the received data that indicate the portions of machine data for events. In general, these properties may include regular expression-based rules or delimiter rules where, for example, event boundaries may be indicated by predefined characters or character strings. These predefined characters may include punctuation marks or other special characters including, for example, carriage returns, tabs, spaces, line breaks, etc. If a sourcetype for the data is unknown to the indexing system 112, the indexing system 112 may infer a sourcetype for the data by examining the structure of the data. Then, the indexing system 112 can apply an inferred sourcetype definition to the data to create the events.

In addition, as part of generating events from the data, the indexing system 112 can determine a timestamp for each event. Similar to the process for parsing machine data, the indexing system 112 may again refer to a sourcetype definition associated with the data to locate one or more properties that indicate instructions for determining a timestamp for each event. The properties may, for example, instruct the indexing system 112 to extract a time value from a portion of data for the event (e.g., using a regex rule), to interpolate time values based on timestamps associated with temporally proximate events, to create a timestamp based on a time the portion of machine data was received or generated, to use the timestamp of a previous event, or use any other rules for determining timestamps, etc.

The indexing system 112 can also associate events with one or more metadata fields. In some embodiments, a timestamp may be included in the metadata fields. These metadata fields may include any number of “default fields” that are associated with all events, and may also include one or more custom fields as defined by a user. In certain embodiments, the default metadata fields associated with each event may include a host, source, and sourcetype field including or in addition to a field storing the timestamp.

In certain embodiments, the indexing system 112 can also apply one or more transformations to event data that is to be included in an event. For example, such transformations can include removing a portion of the event data (e.g., a portion used to define event boundaries, extraneous characters from the event, other extraneous text, etc.), masking a portion of event data (e.g., masking a credit card number), removing redundant portions of event data, etc. The transformations applied to event data may, for example, be specified in one or more configuration files and referenced by one or more sourcetype definitions.

At block 206, the indexing system 112 can group events. In some embodiments, the indexing system 112 can group events based on time. For example, events generated within a particular time period or events that have a timestamp within a particular time period can be grouped together to form a bucket. A non-limiting example of a bucket is described herein with reference to FIG. 3B.

In certain embodiments, multiple components of the indexing system, such as an indexing node, can concurrently generate events and buckets. Furthermore, each indexing node that generates and groups events can concurrently generate multiple buckets. For example, multiple processors of an indexing node can concurrently process data, generate events, and generate buckets. Further, multiple indexing nodes can concurrently generate events and buckets. As such, ingested data can be processed in a highly distributed manner.

In some embodiments, as part of grouping events together, the indexing system 112 can generate one or more inverted indexes for a particular group of events. A non-limiting example of an inverted index is described herein with reference to FIG. 3C. In certain embodiments, the inverted indexes can include location information for events of a bucket. For example, the events of a bucket may be compressed into one or more files to reduce their size. The inverted index can include location information indicating the particular file and/or location within a particular file of a particular event.

In certain embodiments, the inverted indexes may include keyword entries or entries for field values or field name-value pairs found in events. In some cases, a field name-value pair can include a pair of words connected by a symbol, such as an equals sign or colon. The entries can also include location information for events that include the keyword, field value, or field value pair. In this way, relevant events can be quickly located. In some embodiments, fields can automatically be generated for some or all of the field names of the field name-value pairs at the time of indexing. For example, if the string “dest=10.0.1.2” is found in an event, a field named “dest” may be created for the event, and assigned a value of “10.0.1.2.” In certain embodiments, the indexing system can populate entries in the inverted index with field name-value pairs by parsing events using one or more regex rules to determine a field value associated with a field defined by the regex rule. For example, the regex rule may indicate how to find a field value for a userID field in certain events. In some cases, the indexing system 112 can use the sourcetype of the event to determine which regex to use for identifying field values.

At block 208, the indexing system 112 stores the events with an associated timestamp in the storage system 116, which may be in a local data store and/or in a shared storage system. Timestamps enable a user to search for events based on a time range. In some embodiments, the stored events are organized into “buckets,” where each bucket stores events associated with a specific time range based on the timestamps associated with each event. As mentioned, FIGS. 3B and 3C illustrate an example of a bucket. This improves time-based searching, as well as allows for events with recent timestamps, which may have a higher likelihood of being accessed, to be stored in a faster memory to facilitate faster retrieval. For example, buckets containing the most recent events can be stored in flash memory rather than on a hard disk. In some embodiments, each bucket may be associated with an identifier, a time range, and a size constraint.

The indexing system 112 may be responsible for storing the events in the storage system 116. As mentioned, the events or buckets can be stored locally on a component of the indexing system 112 or in a shared storage system 116. In certain embodiments, the component that generates the events and/or stores the events (indexing node) can also be assigned to search the events. In some embodiments separate components can be used for generating and storing events (indexing node) and for searching the events (search node).

By storing events in a distributed manner (either by storing the events at different components or in a shared storage system 116), the query system 114 can analyze events for a query in parallel. For example, using map-reduce techniques, multiple components of the query system (e.g., indexing or search nodes) can concurrently search and provide partial responses for a subset of events to another component (e.g., search head) that combines the results to produce an answer for the query. By storing events in buckets for specific time ranges, the indexing system 112 may further optimize the data retrieval process by the query system 114 to search buckets corresponding to time ranges that are relevant to a query. In some embodiments, each bucket may be associated with an identifier, a time range, and a size constraint. In certain embodiments, a bucket can correspond to a file system directory, and the machine data, or events, of a bucket can be stored in one or more files of the file system directory. The file system directory can include additional files, such as one or more inverted indexes, high-performance indexes, permissions files, configuration files, etc.

In embodiments where components of the indexing system 112 store buckets locally, the components can include a home directory and a cold directory. The home directory can store hot buckets and warm buckets, and the cold directory stores cold buckets. A hot bucket can refer to a bucket that is capable of receiving and storing additional events. A warm bucket can refer to a bucket that can no longer receive events for storage, but has not yet been moved to the cold directory. A cold bucket can refer to a bucket that can no longer receive events and may be a bucket that was previously stored in the home directory. The home directory may be stored in faster memory, such as flash memory, as events may be actively written to the home directory, and the home directory may typically store events that are more frequently searched and thus are accessed more frequently. The cold directory may be stored in slower and/or larger memory, such as a hard disk, as events are no longer being written to the cold directory, and the cold directory may typically store events that are not as frequently searched and thus are accessed less frequently. In some embodiments, components of the indexing system 112 may also have a quarantine bucket that contains events having potentially inaccurate information, such as an incorrect timestamp associated with the event or a timestamp that appears to be an unreasonable timestamp for the corresponding event. The quarantine bucket may have events from any time range; as such, the quarantine bucket may always be searched at search time. Additionally, components of the indexing system may store old, archived data in a frozen bucket that is not capable of being searched at search time. In some embodiments, a frozen bucket may be stored in slower and/or larger memory, such as a hard disk, and may be stored in offline and/or remote storage.

In some embodiments, components of the indexing system 112 may not include a cold directory and/or cold or frozen buckets. For example, in embodiments where buckets are copied to a shared storage system 116 and searched by separate components of the query system 114, buckets can be deleted from components of the indexing system as they are stored to the storage system 116. In certain embodiments, the shared storage system 116 may include a home directory that includes warm buckets copied from the indexing system 112 and a cold directory of cold or frozen buckets as described above.

FIG. 3A is a block diagram illustrating an embodiment of machine data received by the system 102. The machine data can correspond to data from one or more host devices 104 or data sources. As mentioned, the data source can correspond to a log file, data stream, or other data structure that is accessible by a host device 104. In the illustrated embodiment of FIG. 3A, the machine data has different forms. For example, the machine data 302 may be log data that is unstructured or that does not have any clear structure or fields, and may include different portions of 302A-302E that correspond to different entries of the log and that are separated by boundaries. Such data may also be referred to as raw machine data.

The machine data 304 may be referred to as structured or semi-structured machine data, as it does include some data in a JavaScript Object Notation (JSON) structure defining certain fields and field values (e.g., machine data 304A showing field name: field values container_name: kube-apiserver, host: ip 172 20 43 173.ec2.internal, pod_id: 0a73017b-4efa-11e8-a4e1-0a2bf2ab4bba, etc.), but other parts of the machine data 304 are unstructured or raw machine data (e.g., machine data 304B). The machine data 306 may be referred to as structured data, as it includes particular rows and columns of data with field names and field values.

In some embodiments, the machine data 302 can correspond to log data generated by a host device 104 configured as an Apache server, the machine data 304 can correspond to log data generated by a host device 104 in a shared computing resource environment, and the machine data 306 can correspond to metrics data. Given the differences between host devices 104 that generated the log data 302 and 304, the form of the log data 302 and 304 is different. In addition, as the log data 304 is from a host device 104 in a shared computing resource environment, it can include log data generated by an application being executed within an isolated execution environment (304B, excluding the field name “log:”) and log data generated by an application that enables the sharing of computing resources between isolated execution environments (all other data in 304). Although shown together in FIG. 3A, it will be understood that machine data with different hosts, sources, or sourcetypes can be received separately and/or found in different data sources and/or host devices 104.

As described herein, the system 102 can process the machine data based on the form in which it is received. In some cases, the intake system 110 can utilize one or more rules to process the data. In certain embodiments, the intake system 110 can enrich the received data. For example, the intake system may add one or more fields to the data received from the host devices 104, such as fields denoting the host, source, sourcetype, index, or tenant associated with the incoming data. In certain embodiments, the intake system 110 can perform additional processing on the incoming data, such as transforming structured data into unstructured data (or vice versa), identifying timestamps associated with the data, removing extraneous data, parsing data, indexing data, separating data, categorizing data, routing data based on criteria relating to the data being routed, and/or performing other data transformations, etc.

In some cases, the data processed by the intake system 110 can be communicated or made available to the indexing system 112, the query system 114, and/or to other systems. In some embodiments, the intake system 110 communicates or makes available streams of data using one or more shards. For example, the indexing system 112 may read or receive data from one shard, and another system may receive data from another shard. As another example, multiple systems may receive data from the same shard.

As used herein, a partition can refer to a logical division of data. In some cases, the logical division of data may refer to a portion of a data stream, such as a shard from the intake system 110. In certain cases, the logical division of data can refer to an index or other portion of data stored in the storage system 116, such as different directories or file structures used to store data or buckets. Accordingly, it will be understood that the logical division of data referenced by the term “partition” will be understood based on the context of its use.

FIGS. 3B and 3C are block diagrams illustrating embodiments of various data structures for storing data processed by the system 102. FIG. 3B includes an expanded view illustrating an example of machine data stored in a data store 310 of the data storage system 116. It will be understood that the depiction of machine data and associated metadata as rows and columns in the table 319 of FIG. 3B is merely illustrative and is not intended to limit the data format in which the machine data and metadata is stored in various embodiments described herein. In one particular embodiment, machine data can be stored in a compressed or encrypted format. In such embodiments, the machine data can be stored with or be associated with data that describes the compression or encryption scheme with which the machine data is stored. The information about the compression or encryption scheme can be used to decompress or decrypt the machine data, and any metadata with which it is stored, at search time.

In the illustrated embodiment of FIG. 3B the data store 310 includes a directory 312 (individually referred to as 312A and 312B) for each index (or partition) that contains a portion of data stored in the data store 310 and a sub-directory 314 (individually referred to as 314A, 314B, and 314C) for one or more buckets of the index. In the illustrated embodiment of FIG. 3B, each sub-directory 314 corresponds to a bucket and includes an event data file 316 (individually referred to as 316A, 316B, and 316C) and an inverted index 318 (individually referred to as 318A, 318B, and 318C). However, it will be understood that each bucket can be associated with fewer or more files and each sub-directory 314 can store fewer or more files.

In the illustrated embodiment, the data store 310 includes a _main directory 312A associated with an index “_main” and a _test directory 312B associated with an index “_test.” However, the data store 310 can include fewer or more directories. In some embodiments, multiple indexes can share a single directory or all indexes can share a common directory. Additionally, although illustrated as a single data store 310, it will be understood that the data store 310 can be implemented as multiple data stores storing different portions of the information shown in FIG. 3C. For example, a single index can span multiple directories or multiple data stores.

Furthermore, although not illustrated in FIG. 3B, it will be understood that, in some embodiments, the data store 310 can include directories for each tenant and sub-directories for each index of each tenant, or vice versa. Accordingly, the directories 312A and 312B can, in certain embodiments, correspond to sub-directories of a tenant or include sub-directories for different tenants.

In the illustrated embodiment of FIG. 3B, two sub-directories 314A and 314B of the _main directory 312A and one sub-directory 312C of the _test directory 312B are shown. The sub-directories 314A, 314B, and 314C can correspond to buckets of the indexes associated with the directories 312A and 312B. For example, the sub-directories 314A and 314B can correspond to buckets “B1” and “B2,” respectively, of the index “_main” and the sub-directory 314C can correspond to bucket “B1” of the index “_test.” Accordingly, even though there are two “B1” buckets shown, as each “B1” bucket is associated with a different index (and corresponding directory 312), the system 102 can uniquely identify them.

Although illustrated as buckets “B1” and “B2,” it will be understood that the buckets (and/or corresponding sub-directories 314) can be named in a variety of ways. In certain embodiments, the bucket (or sub-directory) names can include information about the bucket. For example, the bucket name can include the name of the index with which the bucket is associated, a time range of the bucket, etc.

As described herein, each bucket can have one or more files associated with it, including, but not limited to, one or more raw machine data files, bucket summary files, filter files, inverted indexes (also referred to herein as high-performance indexes or keyword indexes), permissions files, configuration files, etc. In the illustrated embodiment of FIG. 3B, the files associated with a particular bucket can be stored in the sub-directory corresponding to the particular bucket. Accordingly, the files stored in the sub-directory 314A can correspond to or be associated with bucket “B1” of index “_main,” the files stored in the sub-directory 314B can correspond to or be associated with bucket “B2” of index “_main,” and the files stored in the sub-directory 314C can correspond to or be associated with bucket “B1” of index “_test.”

FIG. 3B further illustrates an expanded event data file 316C showing an example of data that can be stored therein. In the illustrated embodiment, four events 320, 322, 324, and 326 of the machine data file 316C are shown in four rows. Each event 320-326 includes machine data 330 and a timestamp 332. The machine data 330 can correspond to the machine data received by the system 102. For example, in the illustrated embodiment, the machine data 330 of events 320, 322, 324, and 326 corresponds to portions 302A, 302B, 302C, and 302D, respectively, of the machine data 302 after it was processed by the indexing system 112.

Metadata 334-338 associated with the events 320-326 is also shown in the table 319. In the illustrated embodiment, the metadata 334-338 includes information about a host 334, source 336, and sourcetype 338 associated with the events 320-326. Any of the metadata can be extracted from the corresponding machine data, or supplied or defined by an entity, such as a user or computer system. The metadata fields 334-338 can become part of, stored with, or otherwise associated with the events 320-326. In certain embodiments, the metadata 334-338 can be stored in a separate file of the sub-directory 314C and associated with the machine data file 316C. In some cases, while the timestamp 332 can be extracted from the raw data of each event, the values for the other metadata fields may be determined by the indexing system 112 based on information it receives pertaining to the host device 104 or data source of the data separate from the machine data.

While certain default or user-defined metadata fields can be extracted from the machine data for indexing purposes, the machine data within an event can be maintained in its original condition. As such, in embodiments in which the portion of machine data included in an event is unprocessed or otherwise unaltered, it is referred to herein as a portion of raw machine data. For example, in the illustrated embodiment, the machine data of events 320-326 is identical to the portions of the machine data 302A-302D, respectively, used to generate a particular event. Similarly, the entirety of the machine data 302 may be found across multiple events. As such, unless certain information needs to be removed for some reasons (e.g., extraneous information, confidential information, etc.), all the raw machine data contained in an event can be preserved and saved in its original form. Accordingly, the data store in which the event records are stored is sometimes referred to as a “raw record data store.” The raw record data store contains a record of the raw event data tagged with the various fields.

In other embodiments, the portion of machine data in an event can be processed or otherwise altered relative to the machine data used to create the event. With reference to the machine data 304, the machine data of a corresponding event (or events) may be modified such that only a portion of the machine data 304 is stored as one or more events. For example, in some cases, only machine data 304B of the machine data 304 may be retained as one or more events, or the machine data 304 may be altered to remove duplicate data, confidential information, etc.

In FIG. 3B, the first three rows of the table 319 present events 320, 322, and 324 and are related to a server access log that records requests from multiple clients processed by a server, as indicated by entry of “access. log” in the source column 336. In the example shown in FIG. 3B, each of the events 320-324 is associated with a discrete request made to the server by a client. The raw machine data generated by the server and extracted from a server access log can include the IP address 1140 of the client, the user id 1141 of the person requesting the document, the time 1142 the server finished processing the request, the request line 1143 from the client, the status code 1144 returned by the server to the client, the size of the object 1145 returned to the client (in this case, the GIF file requested by the client), and the time spent 1146 to serve the request in microseconds. In the illustrated embodiments of FIGS. 3A and 3B, all the raw machine data retrieved from the server access log is retained and stored as part of the corresponding events 320-324 in the file 316C.

Event 326 is associated with an entry in a server error log, as indicated by “error. log” in the source column 336 that records errors that the server encountered when processing a client request. Similar to the events related to the server access log, all the raw machine data in the error log file pertaining to event 326 can be preserved and stored as part of the event 326.

Saving minimally processed or unprocessed machine data in a data store associated with metadata fields in the manner similar to that shown in FIG. 3B is advantageous because it allows a search of all the machine data at search time instead of searching only previously specified and identified fields or field-value pairs. As mentioned above, because data structures used by various embodiments of the present disclosure maintain the underlying raw machine data and use a late-binding schema for searching the raw machines data, it enables a user to continue investigating and learn valuable insights about the raw data. In other words, the user is not compelled to know about all the fields of information that will be needed at data-ingestion time. As a user learns more about the data in the events, the user can continue to refine the late-binding schema by defining new extraction rules, or modifying or deleting existing extraction rules used by the system.

FIG. 3C illustrates an embodiment of another file that can be included in one or more sub-directories 314 or buckets. Specifically, FIG. 3C illustrates an exploded view of an embodiment of an inverted index 318B in the sub-directory 314B, associated with bucket “B2” of the index “_main,” as well as an event reference array 340 associated with the inverted index 318B.

In some embodiments, the inverted indexes 318 can correspond to distinct time-series buckets. As such, each inverted index 318 can correspond to a particular range of time for an index. In the illustrated embodiment of FIG. 3C, the inverted indexes 318A and 318B correspond to the buckets “B1” and “B2,” respectively, of the index “_main,” and the inverted index 318C corresponds to the bucket “B1” of the index “_test.” In some embodiments, an inverted index 318 can correspond to multiple time-series buckets (e.g., can include information related to multiple buckets) or inverted indexes 318 can correspond to a single time-series bucket.

Each inverted index 318 can include one or more entries, such as keyword (or token) entries 342 or field-value pair entries 344. Furthermore, in certain embodiments, the inverted indexes 318 can include additional information, such as a time range 346 associated with the inverted index or an index identifier 348 identifying the index associated with the inverted index 318. It will be understood that each inverted index 318 can include less or more information than depicted. For example, in some cases, the inverted indexes 318 may omit a time range 346 and/or index identifier 348. In some such embodiments, the index associated with the inverted index 318 can be determined based on the location (e.g., directory 312) of the inverted index 318 and/or the time range of the inverted index 318 can be determined based on the name of the sub-directory 314.

Token entries, such as token entries 342 illustrated in inverted index 318B, can include a token 342A (e.g., “error,” “itemID,” etc.) and event references 342B indicative of events that include the token. For example, for the token “error,” the corresponding token entry includes the token “error” and an event reference, or unique identifier, for each event stored in the corresponding time-series bucket that includes the token “error.” In the illustrated embodiment of FIG. 3C, the error token entry includes the identifiers 3, 5, 6, 8, 11, and 12 corresponding to events located in the bucket “B2” of the index “_main.”

In some cases, some token entries can be default entries, automatically determined entries, or user-specified entries. In some embodiments, the indexing system 112 can identify each word or string in an event as a distinct token and generate a token entry for the identified word or string. In some cases, the indexing system 112 can identify the beginning and ending of tokens based on punctuation, spaces, etc. In certain cases, the indexing system 112 can rely on user input or a configuration file to identify tokens for token entries 342, etc. It will be understood that any combination of token entries can be included as a default, automatically determined, or included based on user-specified criteria.

Similarly, field-value pair entries, such as field-value pair entries 344 shown in inverted index 318B, can include a field-value pair 344A and event references 344B indicative of events that include a field value that corresponds to the field-value pair (or the field-value pair). For example, for a field-value pair sourcetype:: sendmail, a field-value pair entry 344 can include the field-value pair “sourcetype::sendmail” and a unique identifier, or event reference, for each event stored in the corresponding time-series bucket that includes a sourcetype “sendmail.”

In some cases, the field-value pair entries 344 can be default entries, automatically determined entries, or user-specified entries. As a non-limiting example, the field-value pair entries for the fields “host,” “source,” and “sourcetype” can be included in the inverted indexes 318 as a default. As such, all of the inverted indexes 318 can include field-value pair entries for the fields “host,” “source,” and “sourcetype.” As yet another non-limiting example, the field-value pair entries for the field “IP_address” can be user-specified and may only appear in the inverted index 318B or the inverted indexes 318A and 318B of the index “_main” based on user-specified criteria. As another non-limiting example, as the indexing system 112 indexes the events, it can automatically identify field-value pairs and create field-value pair entries 344. For example, based on the indexing system's 212 review of events, it can identify IP_address as a field in each event and add the IP_address field-value pair entries to the inverted index 318B (e.g., based on punctuation, like two keywords separated by an ‘=’ or ‘:’ etc.). It will be understood that any combination of field-value pair entries can be included as a default, automatically determined, or included based on user-specified criteria.

With reference to the event reference array 340, each unique identifier 350, or event reference, can correspond to a unique event located in the time series bucket or machine data file 316B. The same event reference can be located in multiple entries of an inverted index 318. For example, if an event has a sourcetype “splunkd,” host “www1” and token “warning,” then the unique identifier for the event can appear in the field-value pair entries 344 “sourcetype::splunkd” and “host::www1,” as well as the token entry “warning.” With reference to the illustrated embodiment of FIG. 3C and the event that corresponds to the event reference 3, the event reference 3 is found in the field-value pair entries 344 “host::hostA,” “source::sourceB,” “sourcetype::sourcetypeA,” and “IP_address::91.205.189.15” indicating that the event corresponding to the event references is from hostA, sourceB, of sourcetypeA, and includes “91.205.189.15” in the event data.

For some fields, the unique identifier is located in only one field-value pair entry for a particular field. For example, the inverted index 318 may include four sourcetype field-value pair entries 344 corresponding to four different sourcetypes of the events stored in a bucket (e.g., sourcetypes: sendmail, splunkd, web_access, and web_service). Within those four sourcetype field-value pair entries, an identifier for a particular event may appear in only one of the field-value pair entries. With continued reference to the example illustrated embodiment of FIG. 3C, since the event reference 7 appears in the field-value pair entry “sourcetype::sourcetypeA,” then it does not appear in the other field-value pair entries for the sourcetype field, including “sourcetype:: sourcetypeB,” “sourcetype::sourcetypeC,” and “sourcetype::sourcetypeD.”

The event references 350 can be used to locate the events in the corresponding bucket or machine data file 316. For example, the inverted index 318B can include, or be associated with, an event reference array 340. The event reference array 340 can include an array entry 350 for each event reference in the inverted index 318B. Each array entry 350 can include location information 352 of the event corresponding to the unique identifier (non-limiting examples: seek address of the event, physical address, slice ID, etc.), a timestamp 354 associated with the event, or additional information regarding the event associated with the event reference, etc.

For each token entry 342 or field-value pair entry 344, the event reference 342B and 344B, respectively, or unique identifiers can be listed in chronological order, or the value of the event reference can be assigned based on chronological data, such as a timestamp associated with the event referenced by the event reference. For example, the event reference 1 in the illustrated embodiment of FIG. 3C can correspond to the first-in-time event for the bucket, and the event reference 12 can correspond to the last-in-time event for the bucket. However, the event references can be listed in any order, such as reverse chronological order, ascending order, descending order, or some other order (e.g., based on time received or added to the machine data file), etc. Further, the entries can be sorted. For example, the entries can be sorted alphabetically (collectively or within a particular group), by entry origin (e.g., default, automatically generated, user-specified, etc.), by entry type (e.g., field-value pair entry, token entry, etc.), or chronologically by when added to the inverted index, etc. In the illustrated embodiment of FIG. 3C, the entries are sorted first by entry type and then alphabetically.

In some cases, inverted indexes 318 can decrease the search time of a query. For example, for a statistical query, by using the inverted index, the system 102 can avoid the computational overhead of parsing individual events in a machine data file 316. Instead, the system 102 can use the inverted index 318 separate from the raw record data store to generate responses to the received queries.

### 3.0. QUERY PROCESSING AND EXECUTION

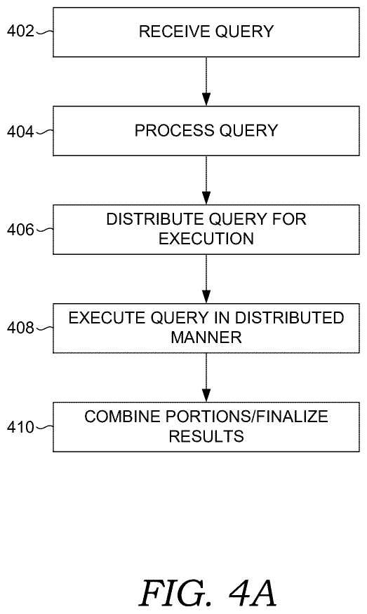

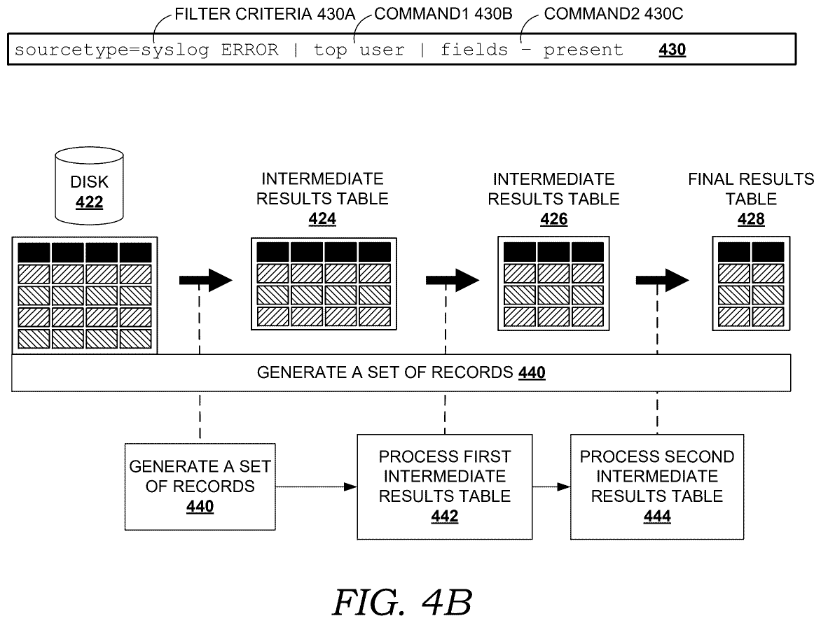

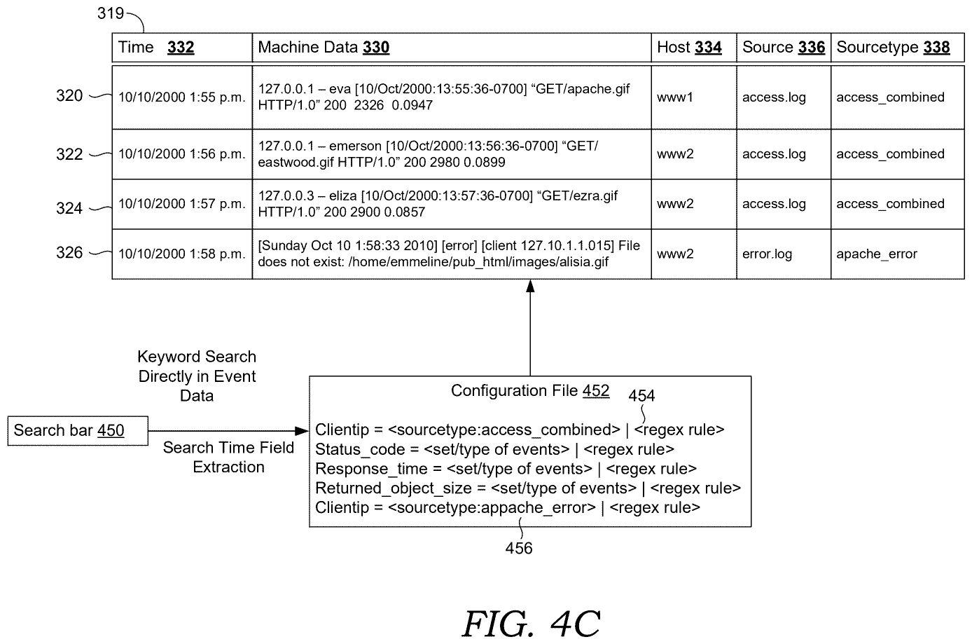

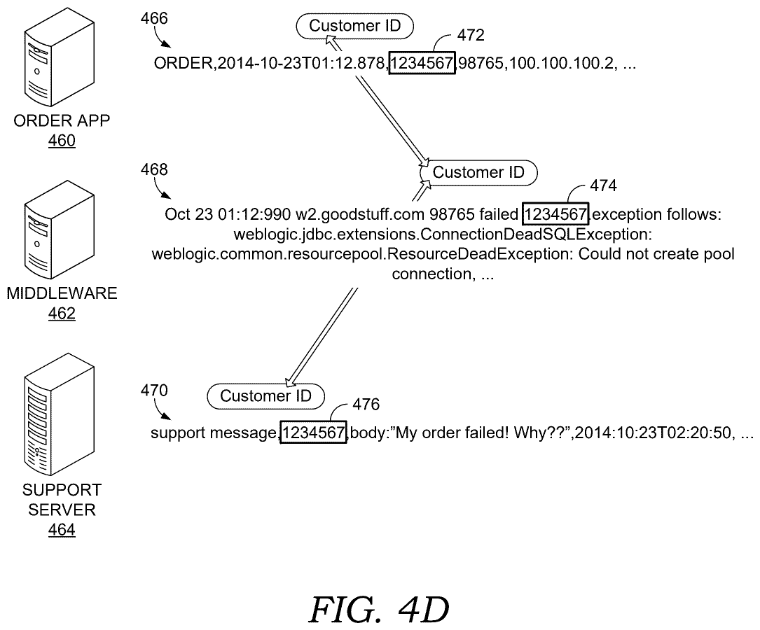

FIG. 4A is a flow diagram illustrating an embodiment of a routine implemented by the query system 114 for executing a query. At block 402, the query system 114 receives a search query. As described herein, the query can be in the form of a pipelined command language or other query language and include filter criteria used to identify a set of data and processing criteria used to process the set of data.

At block 404, the query system 114 processes the query. As part of processing the query, the query system 114 can determine whether the query was submitted by an authenticated user and/or review the query to determine that it is in a proper format for the data intake and query system 102, has correct semantics and syntax, etc. In addition, the query system 114 can determine what, if any, configuration files or other configurations to use as part of the query.

In addition, as part of processing the query, the query system 114 can determine what portion(s) of the query to execute in a distributed manner (e.g., what to delegate to search nodes) and what portions of the query to execute in a non-distributed manner (e.g., what to execute on the search head). For the parts of the query that are to be executed in a distributed manner, the query system 114 can generate specific commands for the components that are to execute the query. This may include generating sub-queries, partial queries, or different phases of the queries for execution by different components of the query system 114. In some cases, the query system 114 can use map-reduce techniques to determine how to map the data for the search and then reduce the data. Based on the map-reduce phases, the query system 114 can generate query commands for different components of the query system 114.

As part of processing the query, the query system 114 can determine where to obtain the data. For example, in some cases, the data may reside on one or more indexing nodes or search nodes as part of the storage system 116, or may reside in a shared storage system or a system external to the system 102. In some cases, the query system 114 can determine what components to use to obtain and process the data. For example, the query system 114 can identify search nodes that are available for the query, etc.

At block 406, the query system 1206 distributes the determined portions or phases of the query to the appropriate components (e.g., search nodes). In some cases, the query system 1206 can use a catalog to determine which components to use to execute the query (e.g., which components include relevant data and/or are available, etc.).

At block 408, the components assigned to execute the query execute the query. As mentioned, different components may execute different portions of the query. In some cases, multiple components (e.g., multiple search nodes) may execute respective portions of the query concurrently and communicate results of their portion of the query to another component (e.g., search head). As part of identifying the set of data or applying the filter criteria, the components of the query system 114 can search for events that match the criteria specified in the query. These criteria can include matching keywords or specific values for certain fields. The searching operations at block 408 may use the late-binding schema to extract values for specified fields from events at the time the query is processed. In some embodiments, one or more rules for extracting field values may be specified as part of a sourcetype definition in a configuration file or in the query itself. In certain embodiments where search nodes are used to obtain the set of data, the search nodes can send the relevant events back to the search head, or use the events to determine a partial result, and send the partial result back to the search head.

At block 410, the query system 114 combines the partial results and/or events to produce a final result for the query. As mentioned, in some cases, combining the partial results and/or finalizing the results can include further processing the data according to the query. Such processing may entail joining different sets of data, transforming the data, and/or performing one or more mathematical operations on the data, preparing the results for display, etc.

In some examples, the results of the query are indicative of performance or security of the IT environment and may help improve the performance of components in the IT environment. This final result may comprise different types of data, depending on what the query requested. For example, the results can include a listing of matching events returned by the query, or some type of visualization of the data from the returned events. In another example, the final result can include one or more calculated values derived from the matching events.

The results generated by the query system 114 can be returned to a client using different techniques. For example, one technique streams results or relevant events back to a client in real-time as they are identified. Another technique waits to report the results to the client until a complete set of results (which may include a set of relevant events or a result based on relevant events) is ready to return to the client. Yet another technique streams interim results or relevant events back to the client in real-time until a complete set of results is ready, and then returns the complete set of results to the client. In another technique, certain results are stored as “search jobs,” and the client may retrieve the results by referring to the search jobs.

The query system 114 can also perform various operations to make the search more efficient. For example, before the query system 114 begins execution of a query, it can determine a time range for the query and a set of common keywords that all matching events include. The query system 114 may then use these parameters to obtain a superset of the eventual results. Then, during a filtering stage, the query system 114 can perform field-extraction operations on the superset to produce a reduced set of search results. This speeds up queries, which may be particularly helpful for queries that are performed on a periodic basis. In some cases, to make the search more efficient, the query system 114 can use information known about certain data sets that are part of the query to filter other data sets. For example, if an early part of the query includes instructions to obtain data with a particular field, but later commands of the query do not rely on the data with that particular field, the query system 114 can omit the superfluous part of the query from execution.

Various embodiments of the present disclosure can be implemented using, or in conjunction with, a pipelined command language. A pipelined command language is a language in which a set of inputs or data is operated on by a first command in a sequence of commands, and then subsequent commands in the order they are arranged in the sequence. Such commands can include any type of functionality for operating on data, such as retrieving, searching, filtering, aggregating, processing, transmitting, and the like. As described herein, a query can thus be formulated in a pipelined command language and include any number of ordered or unordered commands for operating on data.

Splunk Processing Language (SPL) is an example of a pipelined command language in which a set of inputs or data is operated on by any number of commands in a particular sequence. A sequence of commands, or command sequence, can be formulated such that the order in which the commands are arranged defines the order in which the commands are applied to a set of data or the results of an earlier executed command. For example, a first command in a command sequence can include filter criteria used to search or filter for specific data. The results of the first command can then be passed to another command listed later in the command sequence for further processing.

In various embodiments, a query can be formulated as a command sequence defined in a command line of a search UI. In some embodiments, a query can be formulated as a sequence of SPL commands. Some or all of the SPL commands in the sequence of SPL commands can be separated from one another by a pipe symbol “|.” In such embodiments, a set of data, such as a set of events, can be operated on by a first SPL command in the sequence, and then a subsequent SPL command following a pipe symbol “|” after the first SPL command operates on the results produced by the first SPL command or other set of data, and so on for any additional SPL commands in the sequence. As such, a query formulated using SPL comprises a series of consecutive commands that are delimited by pipe “|” characters. The pipe character indicates to the system that the output or result of one command (to the left of the pipe) should be used as the input for one of the subsequent commands (to the right of the pipe). This enables formulation of queries defined by a pipeline of sequenced commands that refines or enhances the data at each step along the pipeline until the desired results are attained. Accordingly, various embodiments described herein can be implemented with Splunk Processing Language (SPL) used in conjunction with the SPLUNK® ENTERPRISE system.

While a query can be formulated in many ways, a query can start with a search command and one or more corresponding search terms or filter criteria at the beginning of the pipeline. Such search terms or filter criteria can include any combination of keywords, phrases, times, dates, Boolean expressions, field name-field value pairs, etc., that specify which results should be obtained from different locations. The results can then be passed as inputs into subsequent commands in a sequence of commands by using, for example, a pipe character. The subsequent commands in a sequence can include directives for additional processing of the results once it has been obtained from one or more indexes. For example, commands may be used to filter unwanted information out of the results, extract more information, evaluate field values, calculate statistics, reorder the results, create an alert, create a summary of the results, or perform some type of aggregation function. In some embodiments, the summary can include a graph, chart, metric, or other visualization of the data. An aggregation function can include analysis or calculations to return an aggregate value, such as an average value, a sum, a maximum value, a root mean square, statistical values, and the like.

Due to its flexible nature, use of a pipelined command language in various embodiments is advantageous because it can perform “filtering” as well as “processing” functions. In other words, a single query can include a search command and search term expressions, as well as data-analysis expressions. For example, a command at the beginning of a query can perform a “filtering” step by retrieving a set of data based on a condition (e.g., records associated with server response times of less than 1 microsecond). The results of the filtering step can then be passed to a subsequent command in the pipeline that performs a “processing” step (e.g., calculation of an aggregate value related to the filtered events such as the average response time of servers with response times of less than 1 microsecond). Furthermore, the search command can allow events to be filtered by keyword as well as field criteria. For example, a search command can filter events based on the word “warning” or filter events based on a field value “10.0.1.2” associated with a field “clientip.”

The results obtained or generated in response to a command in a query can be considered a set of results data. The set of results data can be passed from one command to another in any data format. In one embodiment, the set of results data can be in the form of a dynamically created table. Each command in a particular query can redefine the shape of the table. In some implementations, an event retrieved from an index in response to a query can be considered a row with a column for each field value. Columns can contain basic information about the data and/or data that has been dynamically extracted at search time.

FIG. 4B provides a visual representation of the manner in which a pipelined command language or query can operate in accordance with the disclosed embodiments. The query 430 can be input by the user and submitted to the query system 114. In the illustrated embodiment, the query 430 comprises filter criteria 430A, followed by two commands 430B and 430C (namely, Command 1 and Command 2). Disk 422 represents data as it is stored in a data store to be searched. For example, disk 422 can represent a portion of the storage system 116 or some other data store that can be searched by the query system 114. Individual rows can represent different events and columns can represent different fields for the different events. In some cases, these fields can include raw machine data, host, source, and sourcetype.

At block 440, the query system 114 uses the filter criteria 430A (e.g., “sourcetype =syslog ERROR”) to filter events stored on the disk 422 to generate an intermediate results table 424. Given the semantics of the query 430 and order of the commands, the query system 114 can execute the filter criteria 430A portion of the query 430 before executing Command 1 or Command 2.

Rows in the table 424 may represent individual records, where each record corresponds to an event in the disk 422 that satisfies the filter criteria. Columns in the table 424 may correspond to different fields of an event or record, such as “user,” “count,” percentage,” “timestamp,” or the raw machine data of an event, etc. Notably, the fields in the intermediate results table 424 may differ from the fields of the events on the disk 422. In some cases, this may be due to the late binding schema described herein that can be used to extract field values at search time. Thus, some of the fields in table 424 may not have existed in the events on disk 422.

Illustratively, the intermediate results table 424 has fewer rows than what is shown in the disk 422 because only a subset of events retrieved from the disk 422 match the filter criteria 430A “sourcetype =syslog ERROR.” In some embodiments, instead of searching individual events or raw machine data, the set of events in the intermediate results table 424 may be generated by a call to a pre-existing inverted index.

At block 442, the query system 114 processes the events of the first intermediate results table 424 to generate the second intermediate results table 426. With reference to the query 430, the query system 114 processes the events of the first intermediate results table 424 to identify the top users according to Command 1. This processing may include determining a field value for the field “user” for each record in the intermediate results table 424, counting the number of unique instances of each “user” field value (e.g., number of users with the name David, John, Julie, etc.) within the intermediate results table 424, ordering the results from largest to smallest based on the count, and then keeping only the top 10 results (e.g., keep an identification of the top 10 most common users). Accordingly, each row of table 426 can represent a record that includes a unique field value for the field “user,” and each column can represent a field for that record, such as field “user,” “count,” and “percentage.”

At block 444, the query system 114 processes the second intermediate results table 426 to generate the final results table 428. With reference to query 430, the query system 114 applies the command “fields—present” to the second intermediate results table 426 to generate the final results table 428. As shown, the command “fields—present” of the query 430 results in one less column, which may represent that a field was removed during processing. For example, the query system 114 may have determined that the field “percentage” was unnecessary for displaying the results based on the Command 2. In such a scenario, each record of the final results table 428 would include a field “user” and “count.” Further, the records in the table 428 would be ordered from largest count to smallest count based on the query commands.

It will be understood that the final results table 428 can be a third intermediate results table, which can be pipelined to another stage where further filtering or processing of the data can be performed, e.g., preparing the data for display purposes, filtering the data based on a condition, performing a mathematical calculation with the data, etc. In different embodiments, other query languages, such as the Structured Query Language (“SQL”), can be used to create a query.

As described herein, extraction rules can be used to extract field-value pairs or field values from data. An extraction rule can comprise one or more regex rules that specify how to extract values for the field corresponding to the extraction rule. In addition to specifying how to extract field values, the extraction rules may also include instructions for deriving a field value by performing a function on a character string or value retrieved by the extraction rule. For example, an extraction rule may truncate a character string or convert the character string into a different data format. Extraction rules can be used to extract one or more values for a field from events by parsing the portions of machine data in the events and examining the data for one or more patterns of characters, numbers, delimiters, etc., that indicate where the field begins and, optionally, ends. In certain embodiments, extraction rules can be stored in one or more configuration files. In some cases, a query itself can specify one or more extraction rules.

In some cases, extraction rules can be applied at data ingest by the intake system 110 and/or indexing system 112. For example, the intake system 110 and indexing system 112 can apply extraction rules to ingested data and/or events generated from the ingested data and store results in an inverted index.

The system 102 advantageously allows for search time field extraction. In other words, fields can be extracted from the event data at search time using late-binding schema as opposed to at data-ingestion time, which was a major limitation of the prior art systems. Accordingly, extraction rules can be applied at search time by the query system 114. The query system can apply extraction rules to events retrieved from the storage system 116 or data received from sources external to the system 102. Extraction rules can be applied to all the events in the storage system 116 or to a subset of the events that have been filtered based on some filter criteria (e.g., event timestamp values, etc.).

FIG. 4C is a block diagram illustrating an embodiment of the table 319 showing events 320-326, described previously with reference to FIG. 3B. As described herein, the table 319 is for illustrative purposes, and the events 320-326 may be stored in a variety of formats in an event data file 316 or raw record data store. Further, it will be understood that the event data file 316 or raw record data store can store millions of events. FIG. 4C also illustrates an embodiment of a search bar 450 for entering a query and a configuration file 452 that includes various extraction rules that can be applied to the events 320-326.

As a non-limiting example, if a user inputs a query into search bar 450 that includes only keywords (also known as “tokens”), e.g., the keyword “error” or “warning,” the query system 114 can search for those keywords directly in the events 320-326 stored in the raw record data store.

As described herein, the indexing system 112 can optionally generate and use an inverted index with keyword entries to facilitate fast keyword searching for event data. If a user searches for a keyword that is not included in the inverted index, the query system 114 may nevertheless be able to retrieve the events by searching the event data for the keyword in the event data file 316 or raw record data store directly. For example, if a user searches for the keyword “eva,” and the name “eva” has not been indexed at search time, the query system 114 can search the events 320-326 directly and return the first event 320. In the case where the keyword has been indexed, the inverted index can include a reference pointer that will allow for a more efficient retrieval of the event data from the data store. If the keyword has not been indexed, the query system 114 can search through the events in the event data file to service the search.

In many cases, a query includes fields. The term “field” refers to a location in the event data containing one or more values for a specific data item. Often, a field is a value with a fixed, delimited position on a line, or a name and value pair, where there is a single value to each field name. A field can also be multivalued—that is, it can appear more than once in an event and have a different value for each appearance, e.g., email address fields. Fields are searchable by the field name or field name-value pairs. Some examples of fields are “clientip” for IP addresses accessing a web server, or the “From” and “To” fields in email addresses.

By way of further example, consider the query, “status=404.” This search query finds events with “status” fields that have a value of “404.” When the search is run, the query system 114 does not look for events with any other “status” value. It also does not look for events containing other fields that share “404” as a value. As a result, the search returns a set of results that are more focused than if “404” had been used in the search string as part of a keyword search. Note also that fields can appear in events as “key=value” pairs, such as “user_name=Bob.” But in most cases, field values appear in fixed, delimited positions without identifying keys. For example, the data store may contain events where the “user_name” value always appears by itself after the timestamp, as illustrated by the following string: “Nov 15 09:33:22 evaemerson.”

FIG. 4C illustrates the manner in which configuration files may be used to configure custom fields at search time in accordance with the disclosed embodiments. In response to receiving a query, the query system 114 determines if the query references a “field.” For example, a query may request a list of events where the “clientip” field equals “127.0.0.1.” If the query itself does not specify an extraction rule and if the field is not an indexed metadata field, e.g., time, host, source, sourcetype, etc., then in order to determine an extraction rule, the query system 114 may, in one or more embodiments, locate configuration file 452 during the execution of the query.

Configuration file 452 may contain extraction rules for various fields, e.g., the “clientip” field. The extraction rules may be inserted into the configuration file 452 in a variety of ways. In some embodiments, the extraction rules can comprise regular expression rules that are manually entered in by the user.

In one or more embodiments, as noted above, a field extractor may be configured to automatically generate extraction rules for certain field values in the events when the events are being created, indexed, or stored, or possibly at a later time. In one embodiment, a user may be able to dynamically create custom fields by highlighting portions of a sample event that should be extracted as fields using a graphical user interface. The system can then generate a regular expression that extracts those fields from similar events and store the regular expression as an extraction rule for the associated field in the configuration file 452.

In some embodiments, the indexing system 112 can automatically discover certain custom fields at index time, and the regular expressions for those fields will be automatically generated at index time and stored as part of the extraction rules in configuration file 452. For example, fields that appear in the event data as “key=value” pairs may be automatically extracted as part of an automatic field discovery process. Note that there may be several other ways of adding field definitions to configuration files in addition to the methods discussed herein.

Events from heterogeneous sources that are stored in the storage system 116 may contain the same fields in different locations due to discrepancies in the format of the data generated by the various sources. For example, event 326 also contains a “clientip” field, however, the “clientip” field is in a different format from events 320, 322, and 324. Furthermore, certain events may not contain a particular field at all. To address the discrepancies in the format and content of the different types of events, the configuration file 452 can specify the set of events to which an extraction rule applies. For example, extraction rule 454 specifies that it is to be used with events having a sourcetype “access_combined,” and extraction rule 456 specifies that it is to be used with events having a sourcetype “apache_error.” Other extraction rules shown in configuration file 452 specify a set or type of events to which they apply. In addition, the extraction rules shown in configuration file 452 include a regular expression for parsing the identified set of events to determine the corresponding field value. Accordingly, each extraction rule may pertain to only a particular type of event. Accordingly, if a particular field, e.g., “clientip” occurs in multiple types of events, each of those types of events can have its own corresponding extraction rule in the configuration file 452, and each of the extraction rules would comprise a different regular expression to parse out the associated field value. In some cases, the sets of events are grouped by sourcetype because events generated by a particular source can have the same format.

The field extraction rules stored in configuration file 452 can be used to perform search-time field extractions. For example, for a query that requests a list of events with sourcetype “access_combined” where the “clientip” field equals “127.0.0.1,” the query system 114 can locate the configuration file 452 to retrieve extraction rule 454 that allows it to extract values associated with the “clientip” field from the events where the sourcetype is “access_combined” (e.g., events 320-324). After the “clientip” field has been extracted from the events 320, 322, and 324, the query system 114 can then apply the field criteria by performing a compare operation to filter out events where the “clientip” field does not equal “127.0.0.1.” In the example shown in FIG. 4C, the events 320 and 322 would be returned in response to the user query. In this manner, the query system 114 can service queries with filter criteria containing field criteria and/or keyword criteria.

It should also be noted that any events filtered by performing a search-time field extraction using a configuration file 452 can be further processed by directing the results of the filtering step to a processing step using a pipelined search language. Using the prior example, a user can pipeline the results of the compare step to an aggregate function by asking the query system 114 to count the number of events where the “clientip” field equals “127.0.0.1.”

By providing the field definitions for the queried fields at search time, the configuration file 452 allows the event data file or raw record data store to be field-searchable. In other words, the raw record data store can be searched using keywords as well as fields, wherein the fields are searchable name-value pairings that can distinguish one event from another event and can be defined in configuration file 452 using extraction rules. In comparison to a search containing field names, a keyword search may result in a search of the event data directly without the use of a configuration file.

Further, the ability to add schema to the configuration file 452 at search time results in increased efficiency and flexibility. A user can create new fields at search time and simply add field definitions to the configuration file 452. As a user learns more about the data in the events, the user can continue to refine the late-binding schema by adding new fields, deleting fields, or modifying the field extraction rules in the configuration file for use the next time the schema is used by the system 102. Because the system 102 maintains the underlying raw data and uses late-binding schema for searching the raw data, it enables a user to continue investigating and learn valuable insights about the raw data long after data-ingestion time. Similarly, multiple field definitions can be added to the configuration file to capture the same field across events generated by different sources or sourcetypes. This allows the system 102 to search and correlate data across heterogeneous sources flexibly and efficiently.

The system 102 can use one or more data models to search and/or better understand data. A data model is a hierarchically structured search-time mapping of semantic knowledge about one or more datasets. It encodes the domain knowledge used to build a variety of specialized searches of those datasets. Those searches, in turn, can be used to generate reports.

The above-described system provides significant flexibility by enabling a user to analyze massive quantities of minimally processed data “on the fly” at search time using a late-binding schema, instead of storing pre-specified portions of the data in a database at ingestion time. This flexibility enables a user to see valuable insights, correlate data, and perform subsequent queries to examine interesting aspects of the data that may not have been apparent at ingestion time.

Performing extraction and analysis operations at search time can involve a large amount of data and require a large number of computational operations, which can cause delays in processing the queries. In some embodiments, the system 102 can employ a number of unique acceleration techniques to speed up analysis operations performed at search time. These techniques include: performing search operations in parallel using multiple components of the query system 114, using an inverted index 118, and accelerating the process of generating reports.

To facilitate faster query processing, a query can be structured such that multiple components of the query system 114 (e.g., search nodes) perform the query in parallel, while aggregation of search results from the multiple components is performed at a particular component (e.g., search head). For example, consider a scenario in which a user enters the query “Search “error”|stats count BY host.” The query system 114 can identify two phases for the query, including: (1) subtasks (e.g., data retrieval or simple filtering) that may be performed in parallel by multiple components, such as search nodes, and (2) a search results aggregation operation to be executed by one component, such as the search head, when the results are ultimately collected from the search nodes.

Based on this determination, the query system 114 can generate commands to be executed in parallel by the search nodes, with each search node applying the generated commands to a subset of the data to be searched. In this example, the query system 114 generates and then distributes the following commands to the individual search nodes: “Search “error”|prestats count BY host.” In this example, the “prestats” command can indicate that individual search nodes are processing a subset of the data and are responsible for producing partial results and sending them to the search head. After the search nodes return the results to the search head, the search head aggregates the received results to form a single search result set. By executing the query in this manner, the system effectively distributes the computational operations across the search nodes while reducing data transfers. It will be understood that the query system 114 can employ a variety of techniques to use distributed components to execute a query. In some embodiments, the query system 114 can use distributed components for only mapping functions of a query (e.g., gather data, applying filter criteria, etc.). In certain embodiments, the query system 114 can use distributed components for mapping and reducing functions (e.g., joining data, combining data, reducing data, etc.) of a query.

### 4.0. EXAMPLE USE CASES

The system 102 provides various schemas, dashboards, and visualizations that simplify developers'tasks to create applications with additional capabilities, including but not limited to security, data center monitoring, IT service monitoring, and client/customer insights.

An embodiment of an enterprise security application is as SPLUNK® ENTERPRISE SECURITY, which performs monitoring and alerting operations and includes analytics to facilitate identifying both known and unknown security threats based on large volumes of data stored by the system 102. The enterprise security application provides the security practitioner with visibility into security-relevant threats found in the enterprise infrastructure by capturing, monitoring, and reporting on data from enterprise security devices, systems, and applications. Through the use of the system's 102 searching and reporting capabilities, the enterprise security application provides a top-down and bottom-up view of an organization's security posture.

An embodiment of an IT monitoring application is SPLUNK® IT SERVICE INTELLIGENCE™, which performs monitoring and alerting operations. The IT monitoring application also includes analytics to help an analyst diagnose the root cause of performance problems based on large volumes of data stored by the system 102, as correlated to the various services an IT organization provides (a service-centric view). This differs significantly from conventional IT monitoring systems that lack the infrastructure to effectively store and analyze large volumes of service-related events. Traditional service monitoring systems typically use fixed schemas to extract data from pre-defined fields at data-ingestion time, wherein the extracted data is typically stored in a relational database. This data extraction process and associated reduction in data content that occurs at data-ingestion time inevitably hampers future investigations, when all of the original data may be needed to determine the root cause of or contributing factors to a service issue.

In contrast, an IT monitoring application system stores large volumes of minimally-processed service-related data at ingestion time for later retrieval and analysis at search time, to perform regular monitoring, or to investigate a service issue. To facilitate this data retrieval process, the IT monitoring application enables a user to define an IT operations infrastructure from the perspective of the services it provides. In this service-centric approach, a service such as corporate e-mail may be defined in terms of the entities employed to provide the service, such as host machines and network devices. Each entity is defined to include information for identifying all of the events that pertain to the entity, whether produced by the entity itself or by another machine, and considering the many various ways the entity may be identified in machine data (such as by a URL, an IP address, or machine name). The service and entity definitions can organize events around a service so that all of the events pertaining to that service can be easily identified. This capability provides a foundation for the implementation of Key Performance Indicators.

As described herein, the system 102 can receive heterogeneous data from disparate systems. In some cases, the data from the disparate systems may be related, and correlating the data can result in insights into client or customer interactions with various systems of a vendor. To aid in the correlation of data across different systems, multiple field definitions can be added to one or more configuration files to capture the same field or data across events generated by different sources or sourcetypes. This can enable the system 102 to search and correlate data across heterogeneous sources flexibly and efficiently.

As a non-limiting example and with reference to FIG. 4D, consider a scenario in which a common customer identifier is found among log data received from three disparate data sources. In this example, a user submits an order for merchandise using a vendor's shopping application program 460 running on the user's system. In this example, the order was not delivered to the vendor's server due to a resource exception at the destination server that is detected by the middleware code 462. The user then sends a message to the customer support server 464 to complain about the order failing to complete. The three systems 460, 462, and 464 are disparate systems that do not have a common logging format. The shopping application program 460 sends log data 466 to the system 102 in one format, the middleware code 462 sends error log data 468 in a second format, and the support server 464 sends log data 470 in a third format.

Using the log data received at the system 102 from the three systems 460, 462, and 464, the vendor can uniquely obtain an insight into user activity, user experience, and system behavior. The system 102 allows the vendor's administrator to search the log data from the three systems 460, 462, and 464, thereby obtaining correlated information, such as the order number and corresponding customer ID number of the person placing the order. The system 102 also allows the administrator to see a visualization of related events via a user interface. The administrator can query the system 102 for customer ID field value matches across the log data from the three systems 460, 462, and 464 that are stored in the storage system 116. While the customer ID field value exists in the data gathered from the three systems 460, 462, and 464, it may be located in different areas of the data given differences in the architecture of the systems. The query system 114 obtains events from the storage system 116 related to the three systems 460, 462, and 464. The query system 114 then applies extraction rules to the events in order to extract field values for the field “customer ID” that it can correlate. As described herein, the query system 114 may apply a different extraction rule to each set of events from each system when the event format differs among systems. In this example, a user interface can display to the administrator the events corresponding to the common customer ID field values 472, 474, and 476, thereby providing the administrator with insight into a customer's experience. The system 102 can provide additional user interfaces and reports to aid a user in analyzing the data associated with the customer.

### 5.0. FACILITATING EFFICIENT CONTENT MANAGEMENT WITHIN A DATA-PROCESSING ENVIRONMENT

Data-processing platforms generally include components that execute various aspects of data processing. For example, a data-processing platform may include indexers, heavy forwarders, search heads, etc. that carry out different aspects related to ingesting, indexing, searching, and/or analysis of data (e.g., from various sources). For example, an indexer may store and index data, and a heavy forwarder may forward data from various sources to the indexers for processing and storage within the data-processing environment. SPLUNK® ENTERPRISE is one example of a data-processing platform that includes indexers, forwarders, and search heads to ingest, index, search, and analyze data.

Such a data processing platform may operate using a daemon or process, which may be referred to herein as a processing daemon, that runs (e.g., on a server) as part of the data-processing platform (e.g., SPLUNK® ENTERPRISE software). In the context of SPLUNK® ENTERPRISE software, the processing daemon may be referred to as splunkd. A processing daemon, such as splunkd, may manage various functionalities, such as, for example, data indexing, searching, and processing. More specifically, a processing daemon may manage the lifecycle of indexed data, handling search requests, and facilitating data ingestion and storage. The processing daemon may operate in conjunction with other components (e.g., indexers, search heads, and forwarders) to provide a comprehensive platform for log management, data analysis, and real-time monitoring.

A processing daemon may operate in accordance with configurations to process incoming data. In this way, a processing daemon (e.g., splunkd) may operate using a configuration file(s) to configure how it processes incoming data. In some cases, properties (also referred to herein as props) configurations and/or transformations (also referred to herein as transforms) configurations may be used to configure the processing of incoming data. A props configuration refers to a configuration (e.g., via a configuration file) that defines how the processing daemon, such as splunkd, parses incoming data. For example, a props. conf configuration file may specify settings such as sourcetype, time zone, character set encoding, line breaking rules, etc., which may facilitate parsing and indexing of incoming data. For instance, a sourcetype configuration may specify the type of data being indexed to facilitate how to parse the data and apply parsing rules, a time format configuration may specify a timestamp format used in incoming data to enable extraction of timestamps, and a line breaker configuration may define patterns for breaking data into individual events. A transforms configuration refers to a configuration (e.g., via a configuration file) that defines custom field extractions, lookups, and other data transformations applied before or during indexing. For example, a transforms. conf configuration file may define custom processing logic to enrich or modify incoming data before indexing. For instance, an extract configuration may define regular expressions to extract custom fields from raw data, a lookup configuration may perform lookups against external files or databases to enrich the indexed data with additional information, and a regex configuration may define custom regular expressions for data processing and extraction. Using such props. conf and/or transforms. conf, a processing daemon may effectively parse, index, and enrich incoming data according to the specified rules and transformations, thereby ensuring indexed data is structured, searchable, and optimized for analysis.

Props and transforms configurations may specify how to process incoming data in association with a particular data attribute, such as a data source of the incoming data. For example, props and transforms configurations may be tailored to a specific data source or technology supported. As such, a props and/or transforms configuration(s) may be included in a technology add-on (TA). A technology add-on may support a particular attribute(s), such as a specific technology, data source, or application. Within a technology add-on, props. conf and transforms. conf configurations may be provided to customize a data processing pipeline for the supported technology. For example, such configurations in a technology add-on may define sourcetypes, field extractions (e.g., identifying and extracting specific fields or attributes from raw data, such as IP addresses, timestamps, usernames, error codes, or other data elements), timestamp recognition, and other parsing rules specific to the data format and structure of a particular data source. In this regard, a first technology add-on may correspond with a first data source, and a second technology add-on may correspond with a second data source.

In some cases, advanced data processing may be desired. Advanced data processing generally refers to more complex data processing tasks that go beyond basic ingestion and search capabilities. For example, advanced data processing may include filtering, masking, noise reduction, transformation, rerouting, etc. In this way, it may be desirable to process data in a more advanced manner during data ingestion (e.g., prior to indexing or storing the data). Although props and transforms configurations facilitate configuration for incoming data to a processing daemon (e.g., splunkd), such configurations are generally not designed for performing advanced data processing tasks. For example, props and transforms configurations may lack comprehensive functionality required for advanced data processing tasks. Further, props and transforms configurations may be for lightweight data preprocessing tasks that can be efficiently executed during the data ingestion process. Performing advanced data processing tasks within props and transforms may lead to performance issues, as such configurations are not optimized for handling or expressing computationally intensive operations. As such, existing technology add-ons that include props and/or transforms configurations for basic data ingestion and/or search do not include configurations for performing advanced data processing.

Accordingly, to enable advanced data processing during ingestion, analytics may be used to perform advanced data processing. As one example, a search language may be used to provide a range of functions, commands, and operators that may be used for data manipulation, transformation, aggregation, and visualization. An example of a search processing language is Splunk Search Processing Language, version 2 (SPL2). In this regard, a search language, such as SPL2, may be used for advanced data processing as it offers a more powerful, expressive, and efficient language for querying, manipulating, and analyzing data.

A data-processing platform (e.g., SPLUNK® ENTERPRISE) operating using a processing daemon (e.g., splunkd), however, may not operate using a search language, such as SPL2, to process data during ingestion. For example, as described, a processing daemon may operate using props and transforms configurations to process data during ingestion. Accordingly, such a data-processing platform operating using a processing daemon may not be able to perform advanced data processing. As such, to perform advanced data processing using search language, an edge processor and/or an ingest processor may be used.

An edge processor generally refers to a component or device that collects, processes, and forwards data from edge locations to a central deployment for further analysis. An edge processor is often deployed in distributed environments where data is generated at remote or edge locations, such as branch offices, retail stores, manufacturing plants, or IoT devices. An edge processor generally collects data from various sources at the edge, such as logs, metrics, events, traces, or sensor data. An edge processor can handle diverse data formats and protocols to ensure compatibility with different types of devices.

An edge processor may perform advanced data processing tasks to facilitate reducing the volume of data transmitted to the central deployment and ensure that relevant and valuable data is forwarded for further analysis. Upon processing data, the edge processor forwards the data to a central deployment for storage, indexing, and/or analysis. For example, an edge processor may provide data to SPLUNK® ENTERPRISE, SPLUNK® OBSERVABILITY, a cold storage, an index, a data lake, Simple Storage Service (S3), etc. In some embodiments, an edge processor may operate on-premises and provide processed data to a central deployment (e.g., on-premises or cloud deployments). As described, an edge processor operates using a search language (e.g., SPL2) and not a processing daemon (e.g., splunkd). Accordingly, existing technology add-ons, including props and/or transforms configurations, cannot be operatively used by an edge processor to perform basic data processing.

As such, for an edge processor to perform basic data processing, basic data processing content existing for a processing daemon (e.g., included in a technology add-on in the form of a props and/or transforms configuration), would need to be rewritten in a search language (SPL2) supported by the edge processor. In this regard, to perform various basic data processing tasks, such as time stamping, field extraction, line breaking, masking, routing, transformations, etc., such tasks would need to be written in SPL2 language so that the edge processor can execute the tasks. Rewriting basic data processing content from a props and transforms configuration format to a search language format (e.g., SPL2) to enable basic data processing at an edge component, however, is tedious, error-prone, unnecessarily consumes computing resources, and does not scale well.

An ingest processor generally refers to a component that handles intake and initial processing within a data processing system, such as SPLUNK® CLOUD. Upon processing data, the ingest processor forwards the data to another component in the cloud, such as an indexer or data store (e.g., Splunk SmartStore, also referred to as S2), which may then be available for searching, analysis, and/or visualization. In some cases, an ingest processor receives incoming data from a forwarder of the SPLUNK® CLOUD. Similar to an edge processor, processing content may be written to a search language format (e.g., SPL2) to enable various content processing at an ingest component.

Accordingly, embodiments described herein are directed to efficient content management within a data-processing environment. As one example, embodiments described herein enable basic data processing content, existing in conventional technology add-ons and/or props and transforms configuration format, to be used by an edge processor and/or ingest processor that operates using a search language (SPL2). Enabling utilization of existing technology add-ons and/or props and transforms configurations in an edge processor and/or ingest processor facilitates quick, effective and efficient management of data-processing. For instance, computing resources are not unnecessarily used to generate new basic data processing content in a particular format (e.g., SPL2) used via the edge processor and/or ingest processor. Further, as generating basic data processing in a search language, such as SPL2, may be inaccurate (e.g., based on familiarity of the language), iterations of testing, implementing, and analyzing may result, thereby increasing the unnecessary utilization of computing resources.

As another example, embodiments described herein enable development or generation of technology add-ons that include content in a search language (e.g., SPL2). In this regard, a technology add-on may be generated that includes advanced data processing content in addition to basic data processing content and/or search content. In some cases, a technology add-on may include different formats of content. For example, basic data processing content and search processing content may be of a props and transforms format, while advanced data processing content may be in a search language format. In other cases, a technology add-on may include a consistent format of content, such as content in a search language format. In embodiments described herein, such processing content may be used and implemented irrespective of the content format included in a technology add-on. Advantageously, data incoming into a data processor, such as an edge processor, can be processed according to a pipeline including various processing content without having to rewrite existing processing content previously included in a technology add-on, thereby increasing computing resource efficiency.

As yet another example, embodiments described herein enable discovery of technology add-ons and/or processing functions via an interactive user interface. For example, in accordance with a particular attribute(s) desired by a user, relevant or related technology add-ons and/or processing functions may be identified and presented to the user. In this regard, a user may view or preview the related processing content and select the particular processing content, or portion thereof, desired to be installed in association with a data processor, such as an edge processor or ingest processor. Advantageously, in addition to facilitating efficient and effective discovery of desired processing content, the amount of candidate processing content is vastly increased as first and third party content developers can facilitate generation of various processing content.

Further, in accordance with embodiments described herein, data processing may be performed in a consistent manner. In this way, irrespective of the data processor on which data is processed (e.g., edge processor or ingest processor), the data processed using a particular processing content may be output in a consistent or unified format or structure. Such a unified output facilitates performing reusable and efficient downstream functionalities, tasks, processing, and/or analysis (e.g., simplifies process for writing downstream functions and processing or analyzing data downstream). For example, if data processed by an edge processor resulted in one output format while data processed by an ingest processor resulted in another output format, different functions may be generated for downstream processing to account for the different output formats. In addition to the computing resources used to generate different downstream functions, the computing resources would also be unnecessarily consumed in an effort to execute using the different functions (e.g., storage of different functions, accessing of different functions, assessing a particular function to utilize, etc.).

### 5.1 OVERVIEW OF EFFICIENT CONTENT MANAGEMENT WITHIN A DATA-PROCESSING ENVIRONMENT

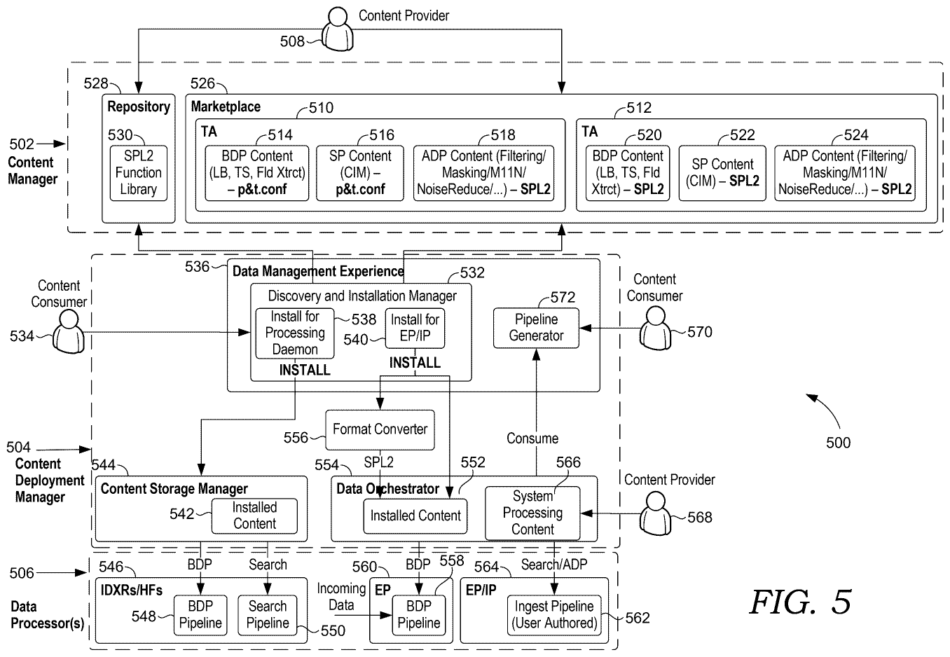

As described, embodiments described herein are directed to facilitating efficient content management within a data-processing environment. In particular, embodiments discussed herein operate in a manner that enables efficient and effective discovery and deployment of processing content, thereby reducing utilization of computing resources. Generally, in accordance with generating or providing various processing content, relevant processing content may be discovered and selected for installation in association with a data processor, such as an indexer, a forwarder, an edge processor, and/or ingest processor. One example environment in which embodiments described herein may be deployed is a data-processing environment that includes a content deployment manager to facilitate deployment of processing content. FIG. 5 provides an example data-processing environment operating to perform discovery and deployment of various processing content in association with one or more data processors, such as an indexer, a forwarder, an edge processor, and/or an ingest processor.

In particular, FIG. 5 provides an example of a data-processing environment 500, in which the technique introduced here can be implemented. The data-processing environment 500 illustrates various implementations that may be employed. As shown, the data-processing environment 500 includes a content manager 502, content deployment manager 504, and a set of data processors 506. The components illustrated in association with the content manager 502, the content deployment manager 504, and the set of data processors 506 may vary depending on a particular implementation employed within a data-processing environment 500.

The content manager 502 is generally configured to manage processing content. Processing content, also referred to herein as content, generally refers to any type of content that describes or indicates a manner in which to process data. Processing content may be used to facilitate performance of basic data processing, advanced data processing, and/or search processing, as described herein. As such, processing content may include basic data processing (BDP) content, advanced data processing (ADP) content, and/or search processing (SP) content. Basic data processing content facilitates performance of basic data processing. Accordingly, basic data processing content may include ingest time content. As raw data is ingested, a basic schema may be provided to perform line breaking, timestamping, and/or field extractions. In this way, basic data processing content indicates a basic shape for data, in some cases irrespective of the destination of the data. A basic or initial schema to apply to data may depend on how the data is getting ingested (e.g., whether incoming payload contains a single event or multiple events, a manner in which to break it into individual events (if multiple events), whether part of the payload is to be discarded, whether part of the payload is to be masked, etc.). Additionally or alternatively, a basic or initial schema to apply to data may depend on other aspects related to the data. For example, basic data processing content may be configured based on a sourcetype associated with the data, a granularity of source type, whether a sourcetype is dynamic based on an attribute in the data, a particular timestamp to be associated with each event, whether to extract a timestamp from incoming data, whether to assign a timestamp, whether certain fields should be extracted out, etc.

Advanced data processing content facilitates performance of advanced data processing. In this way, advanced data processing content may be used to perform domain based schematization (e.g., OCSF), filtering, masking, metricization (e.g., converting data into meaningful metrics or measurements that can be analyzed and/or visualized), noise reduction (e.g., removing or minimizing irrelevant or unwanted data points or fluctuations), etc. In embodiments, advanced data processing content includes content used to transform data based on specific business requirements. In some cases, advanced data processing content is generated based on an initial shape of data, how an end-user(s) expects the data or uses the data, etc. For example, assume CloudTrail data is to be processed. CloudTrail data may include audit logs of actions taken by users, applications, and/or services. CloudTrail data may be used in different manners for different individuals or entities. For instance, one individual (e.g., a security persona) may filter out identity and access management data and send such data to a separate index. Another individual (e.g., a devops persona) may filter out data indicating failures, convert it to a metric, and send it to a separate index. Accordingly, advanced data processing content may be generated or developed in accordance with the subsequent implementation desired.

Search processing content facilitates performance of search processing. Search processing content may include content related to common information model (CIM). Common information model refers to a standardized model that defines a common set of field names and event types for different types of data, enabling consistent and meaningful searches and analysis across disparate data sources. As such, search time content may ensure data ingested is compatible with CIM standards.

The content manager 502 may obtain processing content, such as basic data processing content, advanced data processing content, search process content, and/or sample data, in any of a number of ways. In one embodiment, a content provider 508 may provide or input processing content via a content developer device. For example, a content provider 508 may input processing content in one or more formats via a user interface. A content provider may be individual or entity that provides processing content. By way of example only, a content provider may be a data-processing developer, a third-party developer, a subject matter expert (e.g., within customer premises), etc. As can be appreciated, any number of content providers may provide processing content. Further, different content providers may provide different types of processing content. As one example, one content provider may provide basic data processing content and search processing content (e.g., in the form of props and transforms configurations), and another content provider may provide advanced data processing content (e.g., in the form of a search language).

Processing content, such as basic data processing content, advanced data processing content, and/or search processing content, may be in various forms. In some cases, processing content may be in a props and transforms form. Props and transforms generally refer to components or configurations used to define how data is processed during indexing and search time. The props. conf file may be used to configure properties for data processing at index time. For instance, the props. conf file may contain settings that control how to index data, such as defining sourcetypes, character set encoding, line breaking rules, timestamp extraction, and more. Configuration settings in props. conf may apply to data as it is being ingested, allowing specification of how to interpret and process incoming data from different sources. The transforms. conf file may be used to define customer field extractions, field transformations, and other data processing operations that can be applied during search time or index time. Configuration settings in transforms. conf may enable custom transformations for fields extracted from raw data, such as renaming fields, extracting additional fields using regular expressions, masking sensitive data, enriching events with data from external sources through lookups, etc. Transforms (e.g., defined via transforms. conf) can be referenced and applied in search queries using a search language (e.g., SPL) command(s) to manipulate the structure or content of the data (e.g., indexed data).

By way of example, basic data processing content, including a line breaking (LB) setting or configuration, a timestamp (TS) setting or configuration, and/or field extraction (fld xtrct) setting or configuration, may be provided in a props and/or transforms format. As another example, search processing content, including common information model (CIM), may be provided in a technology add-on using a props and/or transforms format. As described, CIM is a standard data model that provides a framework for organizing and understanding data from various sources within an IT environment. CIM facilitates field extractions, event types, and tags aligned with the CIM standard and may enable ingestion and data analysis from various sources while maintaining consistency and interoperability with the CIM framework.

In other cases, processing content may be in a search language (e.g., SPL2) form. As described, one example search language is SPL2. SPL2 includes a streamlined and intuitive syntax for writing search queries. This search language includes simplified command names, consistent argument ordering, and clear syntax for specifying commands and arguments. SPL2 enables users to define reusable subsearches, macros, and modules within their search queries, thereby enhancing code readability, maintainability, and reusability, making it easier to manage complex search queries and promote best practices. SPL2 may improve search query performance, such as query planning and execution improvements, better resource utilization, and enhanced parallelization of search tasks. These optimizations help to reduce search execution times and improve overall system performance.

Processing content that may be in a search language form (e.g., SPL2) include basic data processing content, search processing content, and/or advanced data processing content. As one example, advanced data processing content (e.g., for filtering, masking noise reduction, etc.) may be in the form of search language. Additionally or alternatively, basic data processing content and/or search processing content may be developed or generated in the form of a search language, such as SPL2.

As shown, processing content may be obtained and/or stored in a number of ways. In some cases, processing content may be obtained or stored via a technology add-on (TA), such as technology add-on 510 and/or 512. A technology add-on refers to a modular component that extends functionality by providing additional support, for example, for specific data sources, data formats, or third-party products. A technology add-on may be used to provide specific capabilities across different use cases. As such, a technology add-on may include pre-built configurations, such as field extractions, sourcetypes, and event types, tailored for a particular technology or data source. Such configurations may facilitate parsing and/or indexing incoming data more accurately, among other things. A technology add-on may also include knowledge objects like saved searches, macros, lookup tables, and dashboards optimized for the technology being supported. A technology add-on may provide integration with third-party products or services, allowing collecting, indexing, and analyzing data from those sources more effectively. For example, technology add-ons may be available for integrating with security appliances, network devices, cloud platforms, and more. Technology add-ons may be designed to be modular, enabling installation of components relevant to a particular environment or use case. Such a modular approach enhances flexibility and scalability, as users can add or remove technology add-ons as needed, without affecting other parts of a data processing deployment.

In accordance with embodiments described herein, a technology add-on may include basic data processing content, advanced data processing content, and/or search processing content. Advantageously, including advanced data processing content in a technology add-on enables data to be processed in advanced manner via the technology add-on in an efficient and effective manner. For example, as advanced data processing content is included in a technology add-on, such content can be discovered and used in a more seamless manner.

In some embodiments, a technology add-on may include processing content configured using different formats. By way of example, a first technology add-on 510 may include basic data processing content 514 and search processing content 516 in props and transforms form, while the advanced data processing content 518 is in the form of SPL2. As existing technology add-ons may include basic data processing content and search processing content in props and transforms form, enabling a technology add-on to include content in both props and transforms and SPL2 form enables technology add-ons to be more readily configured or adjusted to include advanced data processing content in SPL2 form. In this way, enabling native technology add-ons to include advanced data processing content allows props and transforms in native form as well as new content in search language (SPL2) form to be implemented. As such, technology add-ons can continue to capture basic data processing content and search processing content via props and transforms, without needing to rewrite such content in a search language form. Further, technology add-ons may capture advanced data processing content using search language (SPL2). Continuing with this example, a second technology add-on 512 may include basic data processing content 520, search processing content 522, and advanced data processing content 524 in the form of SPL2. In this way, a content provider or developer may author a technology add-on fully using a search language, such as SPL2.

Accordingly, for newly developed technology add-ons, a content provider, such as content provider 508, may format content using props and transforms and/or a search language. In accordance with embodiments described herein, various data processors 506 may be configured to operate to perform basic data processing, advanced data processing, and/or search processing in accordance with technology add-ons, irrespective of whether the technology add-ons include props and transforms and/or search language formats. Further, as the technology add-ons described herein include advanced data processing content, data processors (e.g., an edge processor and/or ingest processor) may perform advanced data processing in association with incoming data. In this regard, technology add-ons may be used as a content packaging and distribution mechanism for varying types of data processors. For example, data processors executing in accordance with a search language (e.g., SPL2), such as edge processors and ingest processors, and data processors executed in accordance with props and transforms (e.g., indexers and forwarders) may operate using technology add-ons as a method for packaging and distributing content. Accordingly, a consistent packaging and distribution structure may be used to distribute various types and formats of processing content to varying data processors that operate in different manners (e.g., SPL2 or splunkd).

Any number of technology add-ons may be generated by any number of content providers. In some cases, a technology add-on may be created or generated in its entirety. For example, a content provider may provide basic data processing content and search processing content using props and transforms and provide advanced data processing content in a search language form. Alternatively, a content provider may provide all processing content in a search language form. In other cases, a technology add-on may be provided by modifying or supplementing a native technology add-on. In this way, a content provider may provide advanced data processing content in search language form to be included in a native technology add-on. As such, the advanced data processing content in search language form may be aggregated with existing basic data processing content and/or search processing content in props and transforms form.

In some cases, a technology add-on may be specific to a data source or a particular technology stack. In this way, processing content that is a function of a data source may be developed inside a technology add-on that is relevant for that data source. As can be appreciated, technology add-ons may be modified or supplemented as needed to adjust the processing content such that a data processor(s) performs data processing as desired. As described, a technology add-on may be used to normalize and enrich data from various sources before indexing the data. A technology add-on may be customized or extended to align with a user's specific requirement or environment. In this way, a user or entity (e.g., organization) may create a technology add-on or modify an existing technology add-on to accommodate unique data sources or configurations.

In some embodiments, technology add-ons, or the content manager 502, may additionally include sample data. Sample data generally refers to data that provides a representation of what actual data may appear when indexed. Sample data may be used, for example, for viewing an outcome associated with BDP and/or ADP content and/or for testing or verifying pipelines or add-on content. Sample data may be curated and/or obtained in any number of ways.

Technology add-ons may be stored in any type of data store or repository. In some embodiments, technology add-ons are stored in association with a marketplace 526, such as Splunkbase. A marketplace, such as Splunkbase, refers to a marketplace for applications, add-ons, and custom visualizations. In operation, marketplace 526 is an online repository in which a user may find, download, and/or share various extensions and solutions to enhance deployments. Generally, a marketplace may offer a range of applications and add-ons, such as technology add-ons covering different use cases, functionalities, and integrations. In embodiments, technology add-ons may be stored in association with a marketplace for integrating specific data sources or technologies with deployments. By hosting technology add-ons in association with a marketplace (e.g., Splunkbase), users may have centralized access to a diverse collection of technology add-ons developed by content providers (e.g., data processing provider and/or consumers or users of data-processing environment). Using such a centralized repository simplifies the process of discovering, downloading, and installing technology add-ons, thereby enabling a more efficient manner in which to support data ingestion and analysis needs. Further, use of a marketplace (e.g., Splunkbase) provides a platform for developers to share technology add-ons with the broader data processing community, thereby increasing collaboration and innovation within the data-processing environment. For example, technology add-ons developed and accessible to a variety of users facilitates adoption of various data integration requirements across different industries and use cases.

In addition or alternatively to providing processing content in technology add-ons (e.g., within a repository such as Splunkbase), in some embodiments, processing content may be provided in repository 528, such as a Git repository. A repository 528, such as a Git repository, may refer to a distributed version control system used for tracking changes in source code during software development. Generally, a Git repository allows multiple developers to collaborate on projects by providing features such as branching, merging, and version history tracking. Git repositories may store a complete history of changes made to a project, along with metadata such as authorship, timestamps, and commit messages.

As such, to enable collaboration among content providers across multiple functions, a repository, such as a Git repository, may be used for authoring processing content functions, such as a search language (SPL2) processing content functions. In some embodiments, repository 528 may host processing content functions (e.g., in SPL2 form). In other embodiments, the repository 528 may host technology add-ons. In some cases, in accordance with processing content functions and/or technology add-ons residing in a repository, such content may be incorporated into a Splunkbase or a technology add-on residing therein. For example, processing content functions generated in association with a Git repository may be accessed and incorporated into a technology add-on in marketplace 526 for a particular data source (e.g., via a content provider).

By way of example only, a repository 528 may include a custom library or set of functions 530. For instance, a set of functions 530 may include SPL2 functions. Such functions 530 may include custom functions (e.g., SPL2 functions) created by users or content developers to extend capabilities, for example, of a search language (e.g., SPL2). In this example, the library of functions 530 may be hosted in a Git repository, but other repositories and/or data stores may be used to host such functions. Utilization of a Git repository to host a function library may allow for version control, collaboration among developers, and easy distribution of the library.

Processing content functions included in a function library, such as function library 530 may be of varying types of processing content or a particular type of processing content. For example, in some cases, processing content functions may be advanced data processing functions. In other cases, processing content functions associated with basic data processing, advanced data processing, and search processing may be included in a function library.

As described herein, the processing content functions included in a function library, such as function library 530, may be functions that perform a particular action and are accessible for subsequent utilization. For instance, the pre-built functions may be analyzed and incorporated into a technology add-on, such as a technology add-on included in marketplace 526. As another example, the pre-built functions may be used to generate a pipeline. For instance, a processing content function that reduces log size for Windows events or reduces log size for Firewall events may be accessed and incorporated into a pipeline for use by an edge processor. As such, the processing content functions enable collaboration between developers to use functions as desired (e.g., in association with a particular data source). Advantageously, such accessible processing content functions may provide usable functions (e.g., pre-generated) that may be immediately employed within a data processor (e.g., an edge processor), as desired by a user. In this way, implementation into a technology add-on is not needed to enable utilization of the developed content processing function.

In accordance with processing content being obtained via content manager 502, the processing content may be accessible to use. In this regard, the content deployment manager 504 is generally configured to manage utilization of the processing content. In this way, the content deployment manager 504 may manage discovering and installing processing content for use via a discovery and installation manager 532.

The discovery and installation manager 532 may enable discovering processing content. In particular, a content consumer, such as content consumer 534, may operate via a user device to facilitate discovery of processing content suitable for data processors 506 to perform initial data processing, advanced data processing, and/or search processing.

In some embodiments, a content consumer 534 may interact with a user interface on a user device to select or input data to discover processing content to install or use to perform basic data processing, advanced data processing, and/or search processing. In accordance with embodiments described herein, any form and/or location of processing content may be discovered. By way of example only, technology add-ons (e.g., via marketplace 526) may be discovered or identified. As another example, processing content functions, such as a SPL2 advanced processing function, may be discovered via repository 528. Further, technology add-ons and/or processing content functions in the form of props and transforms and/or a search language (e.g., SPL2) may be discovered.

In implementation, the processing content discovered may be based on input provided by the content consumer or automatically identified (e.g., in accordance with data being analyzed, interactions of the content consumer, etc.). In some cases, the location from which to discover content and/or the type of content to discover may be specified. For instance, a content consumer may select to discover technology add-ons from marketplace 526. In another example, a content consumer may select to discover processing functions from a repository 528.

In some embodiments, the discovery and installation manager 532 is included or incorporated into a data management experience 536. A data management experience 536 generally enables content consumers to manage various data-processing tasks. For example, data management experience 536 may provide a consistent experience to manage data ingestion, data collection, data processing, pipeline generation, data processor monitoring (e.g., monitoring of forwarders, indexes, edge processors, etc.), and/or the like. Accordingly, the discovery and installation manager 532 may be included in a data management experience 536 to provide a centralized and/or unified experience for managing data.

As described, processing content identified as relevant may be presented to the content consumer. For example, a content consumer may input, via a user interface, a data source, a source type, a preferred form of processing content, a location from which to discover processing content, and/or the like. Based on the input, relevant processing content may be identified and presented to the content consumer. In some cases, any processing content identified as relevant may be presented. In other cases, processing content may be filtered, ranked, and/or selected to recommend as relevant processing content. Further, in embodiments, processing content to present may be based on various attributes in addition to the user input. For instance, based on data being analyzed or previous content consumer preferences or selections, one or more attributes may be identified and used to discover relevant processing content. As one example, assume a content consumer inputs or selects cloud trail data to be processed. Based on the input of the particular data being managed, the discovery and installation manager 532 may identify a technology add-on via the marketplace 526 and various advanced data processing functions via repository 528 related to such cloud trail data and present an indication of the identified processing content. In this way, a content consumer may explore and search for various processing content related to data of interest (e.g., associated with a particular data source, etc.).

In accordance with discovering and presenting processing content, particular processing content may be selected for installation. For example, assume a content consumer is presented with multiple technology add-ons and/or processing content functions that may be relevant to a particular data source associated with the data. In such a case, a user may select one or more technology add-ons and/or processing content functions to install.

The discovery and installation manager 532 may identify a location or data processor for installing the processing content. In accordance with some embodiments described herein, processing content may be installed across different types of data processors. For example, and as described more fully herein, data processors may include indexers, forwarders, edge processors, ingest processors, and/or the like. Accordingly, the discovery and installation manager 532 may identify a data processor(s) for which the processing content is to be installed.

In some cases, a content consumer, such as content consumer 534, may select or specify a data processor(s), environment, or location for which processing content may be installed. For example, a content consumer may select to install processing content for utilization in a SPLUNK ENTERPRISE or splunkd environment, such as data processor 546. As another example, a content consumer may select to install processing content for utilization in a search language (e.g., SPL2) environment, such as data processor 560 and/or data processor 564. In some cases, a content consumer may provide more specificity and select to install processing content for utilization in an edge processor(s) or ingest processor(s). In this regard, the content consumer may understand or recognize whether incoming data is being processed through indexers, heavy forwarders, edge processor, etc. and, based on such a data processor, specify or select installation in association therewith.

In other cases, discovery and installation manager 532 may automatically identify a data processor(s), environment, or location for which processing content may be installed. For example, based on a data type, a data source, etc. associated with the data, a corresponding data processor may be selected for processing the data. As another example, assume a technology add-on is selected as relevant to the data. In such a case, the technology add-on may be identified to have SPL2 content and, as such, a data processor operating via SPL2 (e.g., an edge processor or ingest processor) may be automatically identified for utilization of processing content. By way of example, a content consumer may select to install processing content for a processing daemon (e.g., splunkd) implementation (e.g., an indexer or forwarder), as shown at 538. Additionally or alternatively, a content consumer may select to install processing content for a search language implementation (e.g., an edge processor or ingest processor), as shown at 540.

In some cases, the content consumer 534 may select an entire technology add-on for installation. In other cases, the content consumer 534 may select a portion of a technology add-on or specific processing functions for installation. For instance, assume a technology add-on is identified as relevant based on a data source associated with the data to be processed. In such a case, a content consumer may select the entire technology add-on for installation. In other cases, the content consumer may select a portion of the technology add-on for installation. For instance, the content consumer may select only advanced data processing content for installation or, further, may select only a particular portion or set of the advanced data processing content (e.g., functionality related to filtering data). As another example, assume a technology add-on is identified as relevant based on a data source associated with the data to be processed. In such a case, the content consumer may select processing content associated with a particular source type (e.g., initial data processing, advanced data processing, and/or search processing content). In this way, only a portion of the technology add-on may be installed.

In selecting processing content to install, in some cases, a preview of the data processing may be provided. For example, in association with different content in a technology add-on, for example data processing output may be generated and presented such that a content consumer may view the results of performing particular processing on subsequent incoming data. By way of example only, assume a technology add-on or a processing function is designed to perform data masking. In association with presenting the technology add-on and an indication of advanced data processing content associated with data masking, a result of masked data may be presented such that the content consumer may recognize whether such data processing is desired.

In accordance with identifying or discovering processing content to install, the discovery and installation manager 532 may facilitate installation of the processing content. As described herein, processing content may be installed for use in processing data. In some cases, processing content may be incorporated into a pipeline to execute on a data processor, such as one or more of the data processors in the set of data processors 506. In other cases, processing content may be used to build or generate a pipeline. Installing processing content, such as a technology add-on, provides additional knowledge about a particular technology, data source, etc. for use in generating a pipeline. In this regard, the processing content is installed within the data-processing environment and used to enhance the data pipeline by providing specialized data processing capabilities for specific data sources, technologies, etc.

A pipeline generally refers to a series of operations or transformations applied, for example, to an incoming data stream. These operations may include parsing, filtering, masking sensitive information, enriching data with additional context, or other custom processing required by the user case. The pipeline may include a sequence of stages where each stage performs a specific operation on data. For example, the first stage might involve parsing raw logs into structured fields, while subsequent stages could involve filtering out irrelevant events, performing field extractions, or applying custom business logic. The pipeline plays a role in preparing the incoming data for indexing and analysis, ensuring that it is properly structured, enriched, and sanitized according to the environment and the specific use case requirements. As described herein, different pipelines may be used. For example, in some cases, a basic data processing pipeline may be used to perform basic data processing and an ingest pipeline may be used to perform advanced data processing and/or search processing.

In one implementation, in accordance with a selection to install processing content, such processing content may be installed in association with the content deployment manager 504. The installed processing content may be used to incorporate into a pipeline(s) operating on a data processor(s). In some cases, the installed processing content, or a portion thereof, is automatically incorporated into or used to update a pipeline. Alternatively or additionally, the installed processing content, or a portion thereof, is used to generate a pipeline(s), which can be executed on a data processor(s).

As one example, assume processing content is selected for installation in association with a processing daemon implementation for use in association with an indexer, forwarder, etc., as shown at 538. In such a case, processing content 542 may be installed at a content storage manager (in Splunk Enterprise) 544. In some cases, the processing content 542 is installed in a props and transforms format, as such a format is utilized in association with corresponding data processors (e.g., data processor 546). In implementation, basic data processing content in the form of props and transforms may be incorporated into or updated in a basic data processing pipeline 548 associated with data processor 546. Basic data processing pipeline 548 may represent the flow of data through various stages of basic data processing before data is indexed and made searchable. Such processing steps or stages may include field extraction, line breaking, etc. Similarly, search processing content in the form of props and transforms may be incorporated into a data processor 546 in a search pipeline 550. A search pipeline generally refers to a sequence of steps involved in executing a search query and/or processing the results (e.g., in association with data ingestion). The props and transforms configurations may be incorporated into the appropriate pipeline (e.g., basic data processing pipeline 548 or search pipeline 550) on a data processor, such as data processor 546. In some cases, the props and transforms configurations may be automatically incorporated or integrated into a pipeline. As one example, the props and transforms configurations may be referenced in a pipeline and made accessible or available to the pipeline for reference. For instance, props. conf and transforms. conf may be stored on an indexer and accessed by a basic data processing pipeline during data ingestion. The basic data processing pipeline may be automatically updated with the applicable props and transforms configurations such that the appropriate configurations may be referenced when using the pipeline to perform data processing. As another example, the props and transforms configurations may be integrated with the pipeline or remotely accessible (e.g., via the content storage manager 544) for reference by the pipeline. In other cases, the props and transforms configurations may be accessible for a user to include any of such props and transforms configurations into a user-generated pipeline. For example, a user may view and modify or edit, as needed, a props and transforms configuration and include or write in a basic data processing pipeline and/or search pipeline.

In accordance with embodiments described herein, in some cases, processing content is in a search language format. For example, a technology add-on may include advanced data processing content in a search language format. As another example, a technology add-on may include each type of processing content in a search language format. As described, in some embodiments, a native data processor 546 may not be configured to operate using a search language format (e.g., SPL2). For example, a data processor 546 that is an indexer or a forwarder operating via splunkd may not operate using SPL2. Accordingly, in some embodiments, the processing content, such as advanced data processing content, in the form of a search language (e.g., SPL2) may be converted to a props and transforms format to install such content. In this regard, a search language to props and transforms converter may be employed to convert SPL2 processing content to props and transforms processing content, which may then be installed at content storage manager 544 and, thereafter, incorporated into the data processor 546 via basic data processing pipeline 548 and/or search pipeline 550.

In another embodiment, to incorporate SPL2 processing content into pipelines 548 and/or 550 of the data processor 546, a SPL2 processing engine may be executed directly on data processor 546. For example, a heavy forwarder or an indexer may use a SPL2 processing engine to execute SPL2 processing content. Utilizing such a processing engine in the data processor (e.g., indexer or forwarder) enables utilization of existing technology add-ons as well as new or updated technology add-ons that include search language functions.

As another example, assume processing content is selected for installation in association with a search language implementation for use in association with data processors that execute in accordance with a search language (e.g., SPL2), as shown at 540. For example, processing content may be selected for installation in association with an edge processor and/or ingest processor. In such a case, processing content 552 may be installed at a data orchestrator 554. In some cases, the processing content 552 is installed in a search language format, as such a format is utilized in association with corresponding data processors. In implementation, processing content already existing in the search language may be installed at data orchestrator 554 accordingly. For example, assume technology add-on 510 is selected for installation. In such a case, advanced data processing content 518 is directly installed to data orchestrator 552. Processing content existing in a different format, such as props and transforms, may be converted to the target search language. For example, processing content, such as basic data processing content 514 and search processing content 516 may be converted to a search language content via format converter 556. In this way, the installed processing content 552 is in a common format that is utilized in conjunction with the corresponding data processor(s). In some cases, processing content, such as basic data processing content and/or search processing content, to convert to a search language content via format converter 556 is obtained based on the data management experience 536 obtaining such content via the content manager, or a portion thereof. In other cases, processing content, such as basic data processing content and/or search processing content (e.g., in props and tranforms form), to convert to a search language content via format converter 556 is obtained based on the data management experience 536 obtaining such content via another component, such as the data processor 546, a search head, an indexer, a forwarder, etc. For example, the data management experience 536 may obtain props and transforms from data processor 546 and, thereafter, provide such props and transforms to the format converter 556 for converting the props and transforms to a search language content for installing the content in a common format that is used in conjunction with the corresponding data processor(s).

The processing content 552 in the form of a search language (SPL2) may be incorporated into or updated in a pipeline. For example, basic data processing content may be incorporated into or modified in a pipeline that performs basic data processing content, such as basic data processing pipeline 558 of data processors 560. In such cases, the basic data processing content may be incorporated automatically into a pipeline, such as basic data processing pipeline 558 existing in a data processors (e.g., edge processor). The basic data processing pipeline 558 may represent the flow of data through various states of basic data processing before data is indexed and searchable. Such processing steps or stages may include field extraction, line breaking, etc. In some cases, the basic data processing pipeline 558 may reference the processing content, as appropriate, such that the processing content may be accessed (e.g., via the data processor or the data orchestrator) and used in performing the pipeline.

As another example, advanced data processing content and/or search processing content may be incorporated into ingest pipeline 562 of data processor 564. In some cases, the processing content may be automatically incorporated or integrated into a pipeline. In other cases, the processing content may be accessible for a user to include in a pipeline generated to be executed via a data processor. For example, a content consumer 570 may view and modify or edit, as needed, advanced data processing content and/or search processing content and incorporate such content into a user generated pipeline, which may then be deployed or executed as ingest pipeline 562 on data processor 564.

In some cases, system processing content may be added to the content deployment manager 504 for utilization. System processing content generally refers to processing content that may be available across and applicable to various content consumers, users, or entities. For instance, processing content that is applicable for data associated with any type of data source may be hosted in association with the data orchestrator 554 for access and/or utilization. By way of example only, a processing function that is data source agnostic may be added as a system processing content (e.g., a flatten JSON function, a CSV to JSON function, a XML to JSON function, a sniff timestamp function, etc.). In some cases, system processing content may be installed or made available via the content deployment manager 504. As one example, the data management experience 536 may obtain processing content that may be used to process data. As another example, the data orchestrator 554 may obtain processing content that may be used to process data. For instance, the data orchestrator 554 may include system processing content 566 that may include basic data processing content, advanced data processing content, and/or search processing content that is related to various data processors. As shown in FIG. 5, in some cases, the system processing content 566 is obtained via input from a content provider 568.

In some cases, system processing content may be selected for installation in association with data processors (e.g., data processors 560 and/or 564). For example, content consumer 534 may interact with data management experience 536 and/or discovery and installation manager 532 to discover system processing content 566 that may be relevant or of interest to the content consumer. In some cases, the discovered system processing content 566 may be used to provide a preview of data processing. In accordance with indicating an interest in system processing content 566, the system processing content 566 may be deployed or executed on a data processor (e.g., data processor 560 and/or data processor 564) or may be available or accessible for generating a pipeline (e.g., a pipeline generated via content consumer 570 via pipeline generator 572) that may be subsequently executed on data processor. In other cases, such system processing content 566 may be automatically installed in association with a data processor, such as data processor 560 and/or data processor 564. For example, in association with installing or updating a pipeline operating on a data processor, system processing content 566, or a portion thereof, may be automatically incorporated into a basic data processing pipeline 558 executing on data processor 560.

In one example implementation, system processing content for basic data processing may be incorporated into the basic data processing pipeline 558 (e.g., automatically or based on a user selection), and system default processing content for advanced data processing and/or search processing may be available or accessible for incorporating into a pipeline (e.g., via pipeline generator). To this end, in accordance with a selection of a system processing content, basic data processing content may be automatically incorporated into pipeline 558 of data processor 560, and the remaining processing content may be available for use in generating a pipeline (e.g., via pipeline generator 572) to execute on the data processor 564. For instance, a content consumer, such as content consumer 570, may provide input to facilitate generating or authoring pipelines for use in performing data processing. Such authored pipelines may be pipelines that perform basic data processing, advanced data processing, and/or search processing. For instance, a content consumer 570 may generate a pipeline using pipeline generator 572 by accessing and incorporating processing content, such as processing content obtained from marketplace 526, repository 528, and/or the system processing content 566. For instance, a content consumer may write or configure a pipeline using available processing functions. Upon completing a pipeline, the pipeline may be deployed or run on a data processor, such as data processor 564 (e.g., edge processor or ingest processor).

In some cases, pipeline generation may be performed via pipeline generator 572 using a pipeline template(s). In this way, a pipeline template may be used in association with installed processing content 552 and/or system processing content 566. A pipeline template generally refers to a pre-defined or customizable framework used to create or configure a pipeline. A pipeline template may include reusable components, stages, or tasks that can be assembled or customized to build specific pipelines tailored to particular use cases or requirements. Using a pipeline template can facilitate efficient generation of a pipeline, as the pipeline is not written from scratch. In some cases, pipeline templates may be included in a technology add-on 510 or 512, a marketplace 526, a repository 528, a system processing content 566, etc. Accordingly, a pipeline template may be discovered therefrom for use in generating a pipeline via pipeline generator 572 to be executed in a data processor (e.g., data processor 564). In this way, the data management experience 536 may be used to facilitate discovery of pipeline templates. As such, relevant pipeline templates (e.g., associated with a data source input or selected) may be presented for display as well as any preview associated with the pipeline template. In accordance with discovering a pipeline template desired for utilization, the template may be used to generate a pipeline to deploy. For instance, using the pipeline generator 572, a content consumer may select to clone a pipeline, modify or edit the cloned pipeline in accordance with desired configurations, and select to install or deploy the pipeline (e.g., via data processor 564).

In some embodiments, a pipeline template may refer to processing content functions. In this way, the pipeline template may reference a function or a module, which may be imported to the pipeline. Using such an implementation facilitates a more efficient update to the pipeline in cases in which processing content functions are updated.

As described, data orchestrator 554 may facilitate integration of various processing content within a data processor(s), such as data processors 560 and/or 564. In embodiments, the data orchestrator 554 is configured to identify types of processing content. As one example, the data orchestrator 554 may identify whether processing content in the installed processing content 552 is basic data processing content, advanced data processing content, or search processing content. In some cases, a type of processing content may be identified based on an annotation associated with such content. Annotations may be identified and/or analyzed as the processing content arrives at the data orchestrator 554. As one example, basic data processing content may be annotated such that the data orchestrator 554 identifies that such content should be executed in accordance with incoming raw data. With props and transforms, the stanza may indicate the type of processing content (e.g., stanza may indicate line breaking or timestamping). For search language functions, such functions are often written by content providers and may be annotated when written to indicate the content (e.g., line breaking, filtering, etc.). Indicating such processing content enables the data orchestrator 554 to determine a manner in which to use the content.

In cases in which the processing content is indicated as basic data processing content, the data orchestrator 554, e.g., via a compiler, may recompile such processing content in a manner that can be used by the data processor (e.g., edge processor). In this regard, the data orchestrator 554 may identify basic data processing content, recompile a basic data processing pipeline associated with an edge processor, and deploy the recompiled basic data processing pipeline on the edge processor.

As described, in some cases, the data orchestrator 554 recompiles the processing content to provide the content in a format that is suitable to a data processor, such as an edge processor or an ingest processor. In this way, the data orchestrator 554, via a compiler, may convert search language content to a dispatch table for incorporation into an initial processing pipeline for an edge processor. As such, the search language (e.g., SPL2) may be converted or compiled into a structure understandable to the edge processor at runtime. As one example, a dispatch table may be used for optimization purposes within the edge processor. A dispatch table generally refers to a data structure that may map keys to functions or actions. As such, converting from SPL2 to a dispatch table generally maps the functionality of SPL2 queries to appropriate actions or functions in a dispatch table. Converting search language content to a dispatch table may enable a more efficient data structure that allows for faster and more streamlined execution. This optimization is particularly beneficial in scenarios where the edge processor handles a large volume of data and/or executes concurrent data processing. The data orchestrator 554 may provide the dispatch table to the edge processor to update the basic data processing pipeline. As can be appreciated, the basic data processing content is automatically incorporated into (e.g., as a reference) the basic data processing pipeline in the edge processor for use in processing subsequent incoming data. In this way, a content consumer discovers desired content and installs such content, which can then be automatically incorporated into a pipeline (e.g., an existing basic data processing pipeline for an edge processor). Other types of processing content, such as advanced processing content and search processing content, may be processed in a similar manner and provided to a data processor (e.g., edge processor or ingest processor).

As described, in some embodiments, processing content obtained at the data orchestrator 554, such as installed processing content 552, may be available for use in generating pipelines. In this regard, processing content may be available to a content consumer 570 to access, import, or use to generate a pipeline. For example, in some cases, installed processing content 552, such as advanced data processing content and search processing content, is available for use by content consumer 570 to author a pipeline that may, thereafter, be deployed on a data processor, such as an edge processor or ingest processor.

For example, assume a data processing function related to reducing AWS cloud trail log sites is available in data orchestration 554. In such a case, a content consumer 570 may interact with data management experience 536 and provide an indication of a desire to generate a pipeline and import such a function into the pipeline. For instance, the pipeline may include an indication that for incoming data, call the data processing function related to reducing cloud trail log sites and route the results to an indexer. In this way, the content consumer did not need to write the logs size reduction function, but rather discover and use it in a pipeline. As such, in accordance with executing a pipeline in association with incoming data, the installed content (e.g., via data orchestrator 554 or edge processor 560) may be called and executed.

With continued reference to FIG. 5 and by way of example only, assume content consumer 534 provides an indication that data processing on raw cloud trail data at an edge processor is desired. In some cases, the content consumer 534 may provide an indication of desired content, such as basic data processing content, advanced data processing content, and/or search content. For example, a content consumer may indicate a desire to perform basic data processing and a desire to generate or author a pipeline(s) (e.g., related to filtering or noise reduction). Further assume that based on the inputs or selections by the content consumer 534, technology add-on 510 is presented as a recommended processing content. In some cases, a preview of data processing results may be presented to the content consumer to facilitate the content consumer's evaluation of the recommended processing content. Based on the content consumer's interest in technology add-on 510, assume the content consumer selects to install the technology add-on in association with an edge processor. Based on the selection to install, the basic data processing content 514 and the search processing content 516 in the props and transforms may be converted (e.g., via format converter 556) to search language content (e.g., SPL2 clauses) and installed on the data orchestrator 554 as installed processing content 552. Further, the advanced data processing content 518, which already conforms to the target search language (e.g., SPL2), is provided to the data orchestrator 554 as installed processing content 552. In this way, each of the basic data processing content, the search processing content, and the advanced data processing content are aggregated in a unified search language for use in subsequent data processing. The data orchestrator 554, via a compiler, can analyze the processing content and determine whether to provide the processing content, or a format thereof, to a data processor, such as the edge processor, or enable the processing content to be available (e.g., to a content consumer) for generating a pipeline. For example, annotations or tags associated with processing content may be analyzed to identify basic data processing content. For processing content indicated as basic data processing content, the processing content may be automatically provided to the basic data processing pipeline 558 of the edge processor 560. In some cases, the basic processing pipeline 558 may be recompiled or reconfigured to include the identified basic data processing content and deployed on the edge processor 560. In this regard, processing content annotated as basic data processing content may be identified and pushed to the edge processor to deploy in the basic data processing pipeline 558 for use in performing data processing. For processing content indicated as advanced data processing content or search processing content, or non-annotated content, the data orchestrator 554 may maintain the processing content for consumption to generate a pipeline(s). In this way, a content consumer 570 may use the pipeline generator 572 to access such content (e.g., via installed processing content 552 and/or system processing content 566) and include such content, or portion thereof, in a new or existing pipeline. Such a generated or updated pipeline may then be deployed in association with a data processor, such as ingest pipeline 562 of data processor 564.

The set of data processors 506 may include any number and type of data processor. A data processor is generally used herein to refer to a component that performs data processing. In some cases, data processors operate using a processing daemon, such as splunkd. For example, data processor 546 may be an indexer, a forwarder (e.g., a heavy forwarder), and/or the like. Such a data processor 546 may operate on-premises or in the cloud. For example, data processor 546 may operate as a component of SPLUNK® ENTERPRISE (e.g., on-premises or in cloud). In other cases, a data processor may operate based on a search language, such as SPL2. For example, such a data processor may be an edge processor or an ingest processor. For instance, data processor 560 is illustrated as an edge processor and data processor 564 is illustrated as being an edge processor or an ingest processor.

An edge process may refer to a component that performs computing near the edge of a network or close to a data source (e.g., co-located in a same network). In some embodiments, an edge processor may be external to a cloud environment (e.g., SPLUNK® CLOUD). In this regard, an edge processor typically executes in a customer's environment, or on-premises) and processes data before it is provided to an indexer or forwarder, etc. An edge processor may receive incoming data as raw data, for example, as it is generated by a data source that is co-located with the edge processor. Upon processing the data, for example by performing basic data processing and/or advanced data processing, the edge processor may provide the processed data to various components. For example, the edge processor may provide the processed data to a data-processing platform, such as SPLUNK® ENTERPRISE (e.g., to an indexer or forwarder), operating either on-premises or in the cloud. As another example, the edge processor may provide processed data (e.g., metrics) to an observability platform that analyzes data (e.g., SPLUNK® Observability). As another example, the edge processor may provide the processed data to an ingest processor. As yet another example, the edge processor may provide the processed data to a data store, such as, for example for cold storage (e.g., S3).

An ingest processor may refer to a component that handles data as it is ingested (e.g., co-located with an indexer to process data before being indexed). In some embodiments, an ingest processor may be a cloud native component. In some cases, an ingest processor may process data after the data has been ingested by a forwarder, an indexer, and/or an edge processor. In other cases, an ingest processor may process raw data obtained from various data sources. An ingest processor may be a component of a cloud environment, such as SPLUNK® CLOUD. Upon processing data, for example by performing basic data processing and/or advanced data processing, the ingest processor may provide the processed data to various components. For example, the ingest processor may provide the processed data to an indexer for indexing or a data storage for storage (e.g., cold storage, such as S2).

As incoming data arrives at a data processor, such as data processors 546, 560, and/or 564, the data processor may execute the corresponding pipeline to effectuate processing of the data, as specified in the pipeline. For instance, as data arrives at edge processor 560, the edge processor may execute the basic data processing pipeline 558 to perform basic data processing functionalities, such as line breaking, timestamp identification, and field extraction. Further, in some cases, an edge processor 560 may also perform advanced data processing and/or search processing in accordance with one or more ingest pipelines 562 (e.g., generated via a content consumer). The data may then be indexed, analyzed, searched, and/or otherwise processed. For example, in some cases, the data may be provided to a cloud environment for enabling data indexing, analysis, and searching. As another example, data obtained at an ingest processor, such as ingest processor 564, may execute the ingest pipeline to perform advanced data processing functionalities, such as filtering, masking, noise reduction, metricization, etc.

In executing a pipeline, in some cases, the processing content, or a version thereof, is incorporated directly into the pipeline. In other cases, the processing content, or a version thereof, is accessible via the pipeline. In this regard, the pipeline may reference or indicate specific processing content to perform a task (e.g., field extraction or noise reduction) and, thereafter, the appropriate processing content may be accessed (e.g., as installed on the data processor or accessible to the data processor) and used to perform or execute the particular task at the data processor.

Upon performing one or more processing tasks (e.g., as indicated or specified via a pipeline(s)), the processed data is output. The processed data may be output to various components that may perform another task, such as another data processing task or a data analysis task. Additionally or alternatively, the processed data may be provided for storage, such cold storage (e.g., via S2 or S3).

### 5.2 METHODS FOR EFFICIENT CONTENT MANAGEMENT WITHIN A DATA-PROCESSING ENVIRONMENT

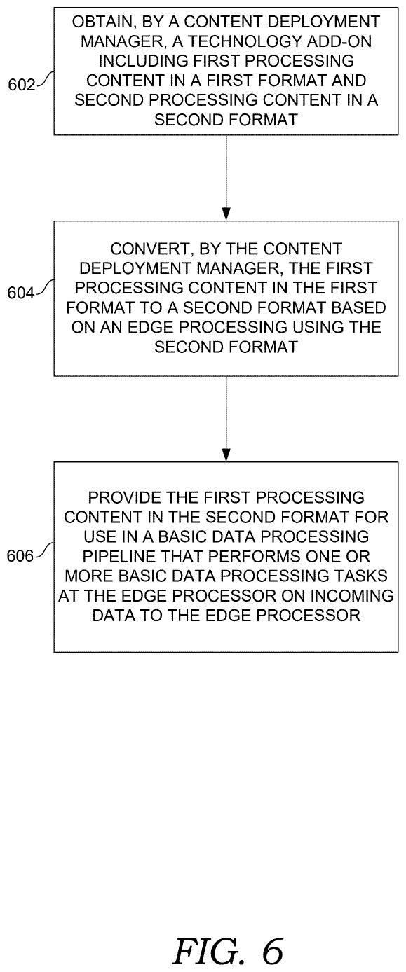

Various methods or implementations may be employed to efficiently and effectively manage analytics, in accordance with embodiments provided herein. FIGS. 6-9 provide some examples, but are not intended to be limited herein. The method and ordering of steps or blocks are not intended to be limiting.

With reference to FIG. 6, FIG. 6 illustrates an example of a process that may be performed to facilitate efficient content management within a data-processing environment, in accordance with embodiments described herein. In some embodiments, aspects of FIG. 6 may be performed by content deployment manager, such as content deployment manager 504 of FIG. 5.

Initially, at block 602, a technology add-on is obtained by a content deployment manager. The technology add-on includes a first processing content in a first format and a second processing content in a second format different from the first format. In embodiments, the first processing content in the first format includes basic data processing content in a props and/or transforms configuration, and the second processing content in the second format includes advanced data processing content in a search language content, such as SPL2. The technology add-on may also include additional content and/or format. For example, the technology add-on may include search processing content in a props and transforms format. In some cases, the technology add-on may be specific to a particular type of data sources, etc. Obtaining the technology add-on may be based on a user, such as a content consumer, selecting to install the technology add-on to the edge processor. In some cases, such a selection may be based on the technology add-on being presented as a recommendation or option to the user, for example, in accordance with the technology add-on having a desired or targeted attribute (e.g., a desired source type, a desired data source, etc.).

At block 604, converting, by the content deployment manager, the first processing content in the first format to the second format based on an edge processor using the first processing content in the second format. As one example, assume the first processing content in the first format includes basic data processing content in a props and/or transforms configuration, and the edge processor operates via a search language format, such as SPL2. In such a case, the props and/or transforms configuration may be converted to the search language format (e.g., SPL2). In some cases, the first processing content in the second format and the second processing content in the second format may be installed. As one example, the first processing content in the second format and the second processing content in the second format may be installed on a data orchestrator that manages such data.

At block 606, the first processing content in the second format is provided for use in a basic data processing pipeline that performs one or more basic data processing tasks at an edge processor on incoming data to the edge processor. For example, the first processing content comprising basic data processing content in a search language format can be provided for use in a basic data processing pipeline that performs basic data processing tasks. In some cases, the first processing content may be provided in a data structure, such as a dispatch table, that is used by the basic data processing pipeline. In some embodiments, the basic data processing pipeline incorporates or integrates the first processing content into the basic data processing pipeline (e.g., as a reference and/or configuration) to perform certain basic data processing tasks, such as line breaking, time stamping, and field extractions. For example, the code or instructions for each task may be preloaded or accessible to the edge processor. In some cases, the instructions for tasks are directly embedded in the pipeline configuration. In this way, the pipeline configuration includes details and parameters for each task, such as the code to be executed, the input data sources, relevant settings, etc. In other cases, instructions for tasks may be stored separately from the pipeline configuration. In this way, the pipeline configuration references external resources or modules where the instructions for a task are defined. When the edge processor executes a pipeline, it can retrieve the appropriate instructions for tasks as needed (e.g., via content installed at the edge processor of a data orchestrator). As incoming data arrives at the edge processor, the basic data processing pipeline may be executed to perform basic data processing tasks in association with the incoming data.

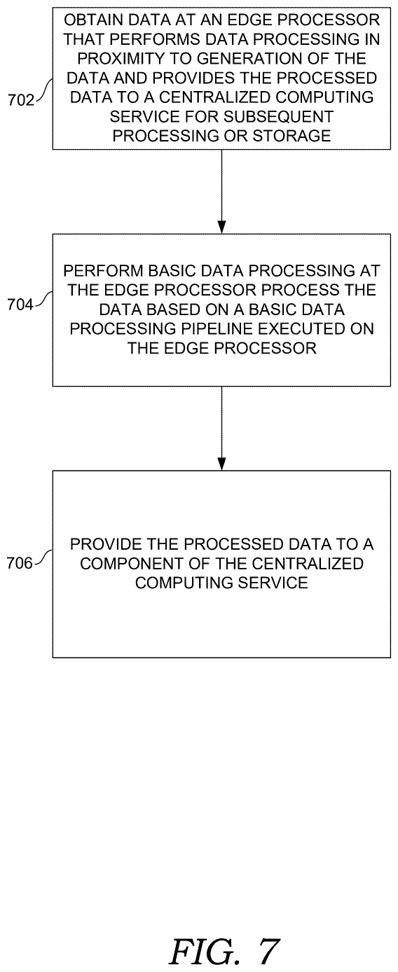

FIG. 7 illustrates an example of a process that may be performed to facilitate efficient content management within a data-processing environment, in accordance with embodiments described herein. In some embodiments, aspects of FIG. 7 may be performed by an edge processor, such as edge processor 560 of FIG. 5.

Initially, at block 702, data is obtained at an edge processor. In embodiments, the edge processor performs data processing in proximity to generation of the data and provides the processed data to a centralized computing service for subsequent processing or storage. In some cases, the data is raw data generated at a data source in proximity (e.g., co-located) to the edge processor. The basic data processing may include various basic data processing tasks, such as a field extraction task, a timestamping task, a line breaking task, a masking task, a routing task, and/or a transformation task.

At block 704, basic data processing is performed at the edge processor to process the data based on a basic data processing pipeline executed on the edge processor. In embodiments, the basic data processing pipeline uses basic data processing content to perform the basic data processing. In some cases, the basic data processing pipeline is updated based on the basic data processing content. The basic data processing content may be incorporated into the basic data processing pipeline by referencing the basic data processing content. In some embodiments, the basic data processing content is in a search language format that was converted from a props and/or transformations configurations format included in a technology add-on. Integrating the basic data processing content with the basic data processing pipeline may be based on a user selection of the content, or a technology add-on associated therewith.

In some cases, the edge processor may additionally or alternatively perform advanced data processing to process the data based on an advanced data processing pipeline executed on the edge processor. The advanced data processing pipeline may use advanced data processing content to perform such advanced data processing. In some cases, an advanced data processing pipeline is generated, via user input, using advanced data processing content included in a technology add-on having the basic data processing content. Advanced data processing may include any number of tasks, such as a filtering task, a masking task, a rerouting task, a noise reduction task, or the like.

At block 706, the processed data is provided to a component of the centralized computing service. In some cases, the processed data is provided to an on-premises data-processing platform or a cloud data-processing platform.

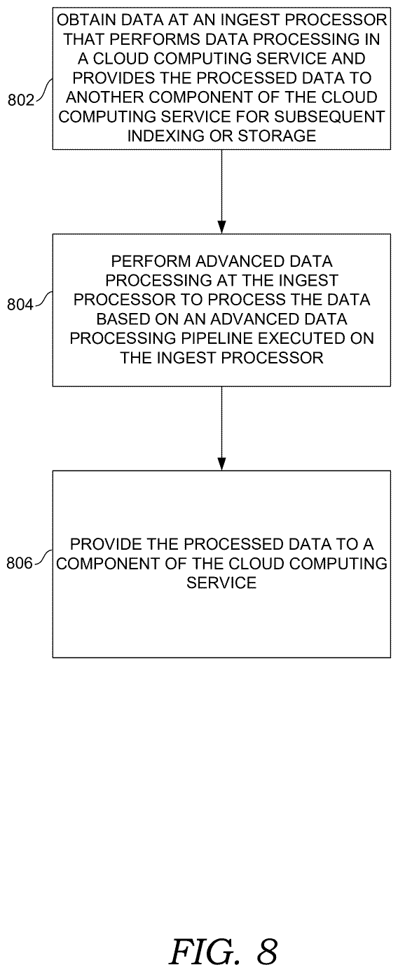

Turning to FIG. 8, FIG. 8 illustrates an example of a process that may be performed to facilitate efficient content management within a data-processing environment, in accordance with embodiments described herein. In some embodiments, aspects of FIG. 8 may be performed by an ingest processor, such as ingest processor 564 of FIG. 5.

Initially, at block 802, data is obtained at an ingest processor. In embodiments, an ingest processor performs data processing in a cloud computing service and provides the processed data to another component of the cloud computing service for subsequent indexing or storage. In some cases, the ingest processor is remote from an on-premises environment hosting a data source at which the data is generated. The data may be obtained from a forwarder of the cloud computing service that performs basic data processing. In some cases, the data obtained may be raw data and, in other cases, the data may be pre-processed data.

At block 804, advanced data processing is performed at the ingest processor to process the data based on an advanced data processing pipeline executed on the ingest processor. In embodiments, the advanced data processing pipeline uses advanced data processing content to perform the advanced data processing. The advanced data processing may include various tasks, such as a masking task, a noise reduction task, a filtering task, a metricization task, etc. In some embodiments, the advanced data processing pipeline is generated using the advanced data processing content included in a technology add-on having basic data processing content. For example, advanced data processing pipeline may be generated by referencing the advanced data processing content in the advanced data processing pipeline and deploying the advanced data processing pipeline on the ingest processor. Additionally or alternatively, the advanced data processing pipeline may be generated using one or more processing functions included in a repository of processing functions.

In some embodiments, the ingest processor may additionally or alternatively perform basic data processing to process the data based on a basic data processing pipeline executed on the ingest processor. The basic data processing pipeline may use basic data processing content to perform the basic data processing. Such basic data processing content may be in a search language that was converted from a properties and transformations configuration format included in a technology add-on.

At block 806, the processed data is provided to a component of the cloud computing service. In some cases, the processed data is provided to an indexer of the cloud computing service. In other cases, the processed data is provided to a data store of the cloud computing service (e.g., for cold storage).

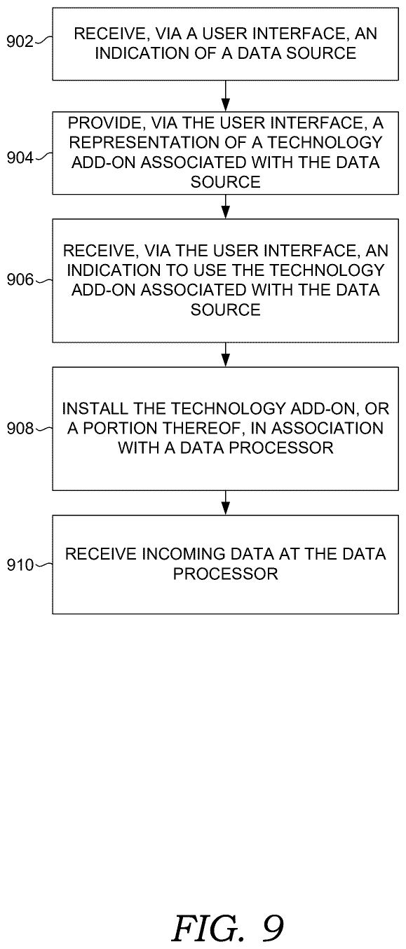

Turning to FIG. 9, FIG. 9 illustrates an example of a process that may be performed to facilitate efficient content management within a data-processing environment, in accordance with embodiments described herein. In some embodiments, aspects of FIG. 9 may be performed by a content deployment manager, such as content deployment manager 504 of FIG. 5.

Initially, at block 902, an indication of a data source is received via a user interface. For example, via a user interface, a user may input or select a data source for which processing content is to be used to update or generate a pipeline.

At block 904, a representation of a technology add-on associated with the data source is provided, via the user interface. In embodiments, the technology add-on may include basic data processing content, advanced data processing content, and/or search processing content. In some cases, basic data processing content may be in the form of props and/or transforms configurations format and advanced data processing content may be in a search language format.

At block 906, an indication to use the technology add-on associated with the data source is received. For example, a user may provide input of an interest in the technology add-on. In some cases, the user may provide input of an interest of a particular portion or aspect of the technology add-on.

At block 908, the technology add-on, or a portion thereof, is installed in association with a data processor. In some cases, the technology add-on, or portion thereof, is installed on a particular data processor based on an indication to install the technology add-on, or the portion thereof, to the particular data processor. The data processor may be an edge processor (e.g., in an on-premises environment), an ingest processor (e.g., in a cloud environment), an indexer, a forwarder, or the like. In one embodiment, the technology add-on may be installed on a data orchestrator. In some cases, basic data processing content of the technology add-on is automatically incorporated into a basic data processing pipeline deployed on the data processor. Additionally or alternatively, advanced data processing content of the technology add-on is incorporated, via the user interface, into an advanced data processing pipeline deployed on the data processor.

At block 910, incoming data is received at the data processor. For example, incoming data may be received as raw data from a data source. At block 912, the incoming data is processed, at the data processor, using a pipeline that incorporates basic data processing content and/or advanced data processing content of the technology add-on.

### 6.0. TERMINOLOGY

Computer programs typically comprise one or more instructions set at various times in various memory devices of a computing device, which, when read and executed by at least one processor, will cause a computing device to execute functions involving the disclosed techniques. In some embodiments, a carrier containing the aforementioned computer program product is provided. The carrier is one of an electronic signal, an optical signal, a radio signal, or a non-transitory computer-readable storage medium.

Any or all of the features and functions described above can be combined with each other, except to the extent it may be otherwise stated above or to the extent that any such embodiments may be incompatible by virtue of their function or structure, as will be apparent to persons of ordinary skill in the art. Unless contrary to physical possibility, it is envisioned that (i) the methods/steps described herein may be performed in any sequence and/or in any combination, and (ii) the components of respective embodiments may be combined in any manner.

Although the subject matter has been described in language specific to structural features and/or acts, it is to be understood that the subject matter defined in the appended claims is not necessarily limited to the specific features or acts described above. Rather, the specific features and acts described above are disclosed as examples of implementing the claims, and other equivalent features and acts are intended to be within the scope of the claims.

Conditional language, such as, among others, “can,” “could,” “might,” or “may,” unless specifically stated otherwise, or otherwise understood within the context as used, is generally intended to convey that certain embodiments include, while other embodiments do not include, certain features, elements and/or steps. Thus, such conditional language is not generally intended to imply that features, elements and/or steps are in any way required for one or more embodiments or that one or more embodiments necessarily include logic for deciding, with or without user input or prompting, whether these features, elements and/or steps are included or are to be performed in any particular embodiment. Furthermore, use of “e.g.,” is to be interpreted as providing a non-limiting example and does not imply that two things are identical or necessarily equate to each other.

Unless the context clearly requires otherwise, throughout the description and the claims, the words “comprise,” “comprising,” and the like are to be construed in an inclusive sense, as opposed to an exclusive or exhaustive sense, i.e., in the sense of “including, but not limited to.” As used herein, the terms “connected,” “coupled,” or any variant thereof means any connection or coupling, either direct or indirect, between two or more elements; the coupling or connection between the elements can be physical, logical, or a combination thereof. Additionally, the words “herein,” “above,” “below,” and words of similar import, when used in this application, refer to this application as a whole and not to any particular portions of this application. Where the context permits, words using the singular or plural number may also include the plural or singular number respectively. The word “or” in reference to a list of two or more items, covers all of the following interpretations of the word: any one of the items in the list, all of the items in the list, and any combination of the items in the list. Likewise the term “and/or” in reference to a list of two or more items, covers all of the following interpretations of the word: any one of the items in the list, all of the items in the list, and any combination of the items in the list.

Conjunctive language such as the phrase “at least one of X, Y and Z,” unless specifically stated otherwise, is understood with the context as used in general to convey that an item, term, etc. may be either X, Y or Z, or any combination thereof. Thus, such conjunctive language is not generally intended to imply that certain embodiments require at least one of X, at least one of Y and at least one of Z to each be present. Further, use of the phrase “at least one of X, Y or Z” as used in general is to convey that an item, term, etc. may be either X, Y or Z, or any combination thereof.

In some embodiments, certain operations, acts, events, or functions of any of the algorithms described herein can be performed in a different sequence, can be added, merged, or left out altogether (e.g., not all are necessary for the practice of the algorithms). In certain embodiments, operations, acts, functions, or events can be performed concurrently, e.g., through multi-threaded processing, interrupt processing, or multiple processors or processor cores or on other parallel architectures, rather than sequentially.

Systems and modules described herein may comprise software, firmware, hardware, or any combination(s) of software, firmware, or hardware suitable for the purposes described. Software and other modules may reside and execute on servers, workstations, personal computers, computerized tablets, PDAs, and other computing devices suitable for the purposes described herein. Software and other modules may be accessible via local computer memory, via a network, via a browser, or via other means suitable for the purposes described herein. Data structures described herein may comprise computer files, variables, programming arrays, programming structures, or any electronic information storage schemes or methods, or any combinations thereof, suitable for the purposes described herein. User interface elements described herein may comprise elements from graphical user interfaces, interactive voice response, command line interfaces, and other suitable interfaces.

Further, processing of the various components of the illustrated systems can be distributed across multiple machines, networks, and other computing resources. Two or more components of a system can be combined into fewer components. Various components of the illustrated systems can be implemented in one or more virtual machines or an isolated execution environment, rather than in dedicated computer hardware systems and/or computing devices. Likewise, the data repositories shown can represent physical and/or logical data storage, including, e.g., storage area networks or other distributed storage systems. Moreover, in some embodiments the connections between the components shown represent possible paths of data flow, rather than actual connections between hardware. While some examples of possible connections are shown, any of the subset of the components shown can communicate with any other subset of components in various implementations.

Embodiments are also described above with reference to flow chart illustrations and/or block diagrams of methods, apparatus (systems) and computer program products. Each block of the flow chart illustrations and/or block diagrams, and combinations of blocks in the flow chart illustrations and/or block diagrams, may be implemented by computer program instructions. Such instructions may be provided to a processor of a general purpose computer, special purpose computer, specially-equipped computer (e.g., comprising a high-performance database server, a graphics subsystem, etc.) or other programmable data-processing apparatus to produce a machine, such that the instructions, which execute via the processor(s) of the computer or other programmable data-processing apparatus, create means for implementing the acts specified in the flow chart and/or block diagram block or blocks. These computer program instructions may also be stored in a non-transitory computer-readable memory that can direct a computer or other programmable data-processing apparatus to operate in a particular manner, such that the instructions stored in the computer-readable memory produce an article of manufacture including instruction means which implement the acts specified in the flow chart and/or block diagram block or blocks. The computer program instructions may also be loaded to a computing device or other programmable data-processing apparatus to cause operations to be performed on the computing device or other programmable apparatus to produce a computer implemented process such that the instructions which execute on the computing device or other programmable apparatus provide steps for implementing the acts specified in the flow chart and/or block diagram block or blocks.

Any patents and applications and other references noted above, including any that may be listed in accompanying filing papers, are incorporated herein by reference. Aspects of the disclosure can be modified, if necessary, to employ the systems, functions, and concepts of the various references described above to provide yet further implementations of the disclosure. These and other changes can be made to the disclosure in light of the above Detailed Description. While the above description describes certain examples of the disclosure, and describes the best mode contemplated, no matter how detailed the above appears in text, the disclosure can be practiced in many ways. Details of the system may vary considerably in its specific implementation, while still being encompassed by the disclosure disclosed herein. As noted above, particular terminology used when describing certain features or aspects of the disclosure should not be taken to imply that the terminology is being redefined herein to be restricted to any specific characteristics, features, or aspects of the disclosure with which that terminology is associated. In general, the terms used in the following claims should not be construed to limit the disclosure to the specific examples disclosed in the specification, unless the above Detailed Description section explicitly defines such terms. Accordingly, the actual scope of the disclosure encompasses not only the disclosed examples, but also all equivalent ways of practicing or implementing the disclosure under the claims.

To reduce the number of claims, certain aspects of the disclosure are presented below in certain claim forms, but the applicant contemplates other aspects of the disclosure in any number of claim forms. For example, while only one aspect of the disclosure is recited as a means-plus-function claim under 35 U.S.C sec. 112(f) (AIA), other aspects may likewise be embodied as a means-plus-function claim, or in other forms, such as being embodied in a computer-readable medium. Any claims intended to be treated under 35 U.S.C. § 112(f) will begin with the words “means for,” but use of the term “for” in any other context is not intended to invoke treatment under 35 U.S.C. § 112(f). Accordingly, the applicant reserves the right to pursue additional claims after filing this application, in either this application or in a continuing application.

What is claimed is:

1. A computer-implemented method, comprising:
obtaining data at an edge processor, wherein the edge processor performs data processing in proximity to generation of the data and provides the processed data to a centralized computing service for subsequent processing or storage;
performing, at the edge processor, basic data processing to process the data based on a basic data processing pipeline executed on the edge processor, wherein the basic data processing pipeline uses basic data processing content to perform the basic data processing; and
providing the processed data to a component of the centralized computing service.

2. The computer-implemented method of claim 1, wherein the data comprises raw data generated at a data source in proximity to the edge processor.

3. The computer-implemented method of claim 1, wherein the basic data processing comprises a field extraction task, a timestamping task, a line breaking task, a masking task, a routing task, or a transformations task.

4. The computer-implemented method of claim 1 further comprising updating the basic data processing pipeline based on the basic data processing content.

5. The computer-implemented method of claim 1 further comprises incorporating a reference to the basic data processing content into the basic data processing pipeline.

6. The computer-implemented method of claim 1, wherein the basic data processing content is in a search language format converted from a props and/or transforms configuration format included in a technology add-on.

7. The computer-implemented method of claim 1, wherein the basic data processing content is integrated with the basic data processing pipeline based on a user selection of the basic data processing content, or a technology add-on associated therewith.

8. The computer-implemented method of claim 1, wherein the basic data processing content is installed on the edge processor.

9. The computer-implemented method of claim 1 further comprising performing, at the edge processor, advanced data processing to process the data based on an advanced data processing pipeline executed on the edge processor, wherein the advanced data processing pipeline uses advanced data processing content to perform the advanced data processing.

10. The computer-implemented method of claim 1 further comprising performing, at the edge processor, advanced data processing to process the data based on an advanced data processing pipeline, wherein the advanced data processing comprises a filtering task, a masking task, a transformation task, a rerouting task, a noise reduction task, or a combination thereof.

11. The computer-implemented method of claim 1, wherein the processed data is provided to an on-premises data-processing platform or a cloud data-processing platform.

12. The computer-implemented method of claim 1, wherein the processed data is provided to a data store.

13. The computer-implemented method of claim 1 further comprising performing, at the edge processor, advanced data processing to process the data based on an advanced data processing pipeline executed on the edge processor, wherein the advanced data processing pipeline is generated, via user input, using advanced data processing content included in a technology add-on having the basic data processing content.

14. The computer-implemented method of claim 1 further comprising performing, at the edge processor, advanced data processing to process the data based on an advanced data processing pipeline executed on the edge processor, wherein the advanced data processing pipeline is generated, via user input, using processing functions included in a repository of processing functions.

15. The computer-implemented method of claim 1, wherein the basic data processing content is integrated with the basic data processing pipeline based on a discovery of the basic data processing content in response to a user input and a user selection of the basic data processing content, or a technology add-on associated therewith.

16. A computing device, comprising:
a processor; and
a non-transitory computer-readable medium having instructions stored thereon that, when executed by the processor, cause the processor to perform operations including:
obtaining data at an edge processor, wherein the edge processor performs data processing in proximity to generation of the data and provides the processed data to a centralized computing service for subsequent processing or storage;
performing, at the edge processor, basic data processing to process the data based on a basic data processing pipeline executed on the edge processor, wherein the basic data processing pipeline uses basic data processing content to perform the basic data processing; and
providing the processed data to a component of the centralized computing service.

17. The computing device of claim 16, wherein the basic data processing content is integrated with the basic data processing pipeline based on a discovery of the basic data processing content in response to a user input and a user selection of the basic data processing content, or a technology add-on associated therewith.

18. A non-transitory computer-readable medium having stored instructions thereon that, when executed by one or more processors, cause the one or more processors to perform operations including:
obtaining data at an edge processor, wherein the edge processor performs data processing in proximity to generation of the data and provides the processed data to a centralized computing service for subsequent processing or storage;
performing, at the edge processor, basic data processing to process the data based on a basic data processing pipeline executed on the edge processor, wherein the basic data processing pipeline uses basic data processing content to perform the basic data processing; and
providing the processed data to a component of the centralized computing service.

19. The medium of claim 18, wherein the operations further comprise updating the basic data processing pipeline based on the basic data processing content.

20. The medium of claim 18, wherein the basic data processing comprises a field extraction task, a timestamping task, a line breaking task, a masking task, a routing task, or a transformations task.
